(19) United States
(12) Patent Application Publication
(10) Pub. No.: US 2026/0137232 A1
(43) Pub. Date: May 21, 2026

(54) SYSTEMS AND METHODS FOR OPERATING BEVERAGE ROBOTS TO PERFORM RECIPE ADJUSTMENTS

(71) Applicant: BOTRISTA, INC., San Francisco, CA (US)

(72) Inventor: Wu-Chou KUO, San Francisco, CA (US)

(21) Appl. No.: 18/952,855

(22) Filed: Nov. 19, 2024

Related U.S. Application Data
(60) Provisional application No. 63/600,955, filed on Nov. 20, 2023.

(51) Int. Cl. A47J 31/52; A47J 31/44

(52) U.S. Cl. CPC A47J 31/521; A47J 31/4492; A47J 31/525

(57) ABSTRACT

A mesh network of food and/or beverage robots, and associated systems and methods, are disclosed herein. For example, a method of operating a beverage robot at a vending location can include analyzing ingredients for beverages and determining if the quality of the ingredient has changed. The method can also include determining an acidity level or a sweetness level of an ingredient. The method can also include adjusting at least one ingredient in the recipe of the beverage based on the determined acidity level or sweetness level.

### CROSS-REFERENCE TO RELATED APPLICATION

This application is a non-provisional of and claims priority to U.S. Provisional Application No. 63/600,955, filed on Nov. 20, 2023, entitled “FOOD STERILIZATION SYSTEM, INGREDIENT MIXING SYSTEM, MULTIPURPOSE BLENDING SYSTEM, BEVERAGE MENU GENERATOR, CONTAINER SQUEEZING DEVICES, FRYER APPARATUS, COFFEE PREPARATION APPARATUS, FLUID DISPENSING SYSTEM, AND RELATED CLOUD SYSTEM,” which is hereby incorporated by reference in its entirety for all purposes.

### TECHNICAL FIELD

The present technology is generally directed to operating robots and more specifically to systems and methods for operating beverage and/or food robots to prepare individual items in an order.

### BACKGROUND

Freshly made beverages are typically more desirable to consumers than factory-produced, canned, or bottled beverages. For example, freshly made beverages can have superior taste, freshness, and/or customizability in the ingredients used in the beverage. Accordingly, restaurants, cafés, coffee shops, and/or other beverage vendors prefer to offer a menu of freshly made beverages. The fresh preparation, however, typically requires the time and attention of vendor personnel, which can slow down order production, causing customer dissatisfaction, reducing the volume of orders vendors can produce, and/or increasing the costs per order. To meet these challenges, vendors have increasingly automated portions, or all, of the production of beverages.

Automation brings about another set of challenges. For example, automating beverage productions requires that vendors be able to maintain, diagnose, and fix the automation systems. Additionally, vendors must be able to track and monitor ingredients and ingredient inventory for the automated systems to avoid preparing contaminated drinks. Still further, vendors must be able to track orders through the automated system to ensure customer satisfaction with the timing, resulting orders, and overall experience.

### BRIEF DESCRIPTION OF THE DRAWINGS

FIG. 1 is a schematic diagram of a system for operating food and/or beverage robots in accordance with some embodiments of the present technology.

FIG. 2 is a schematic network diagram of a system for operating a network of food and/or beverage robots in accordance with some embodiments of the present technology.

FIG. 3 is a block diagram of a platform for operating a network of beverage robots in accordance with some embodiments of the present technology.

FIG. 4 is a block diagram of a subsystem for a beverage robot in accordance with some embodiments of the present technology.

FIG. 5 is a schematic front view of a beverage robot configured in accordance with some embodiments of the present technology.

FIG. 6 is a schematic diagram of a mesh network with a plurality of beverage robots configured in accordance with some embodiments of the present technology.

FIG. 7 is a flow diagram of a process for operating a mesh network with a plurality of beverage robots in accordance with some embodiments of the present technology.

FIG. 8 is a flow diagram of a process for determining robot functionality within a mesh network with a plurality of beverage robots in accordance with some embodiments of the present technology.

FIG. 9 is a flow diagram of a process for adjusting recipe ratios of orders in production at a plurality of beverage robots in accordance with some embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

### Overview

Disclosed are methods and systems for transmitting instructions between a recipe and robot management system and a distributed network of beverage robots. The management system centrally manages menu and recipe distribution, robot user-interface customization, ingredient information, point-of-sale (POS) integrations, operational and error code communications, and order management for consumable products associated with customers and robots.

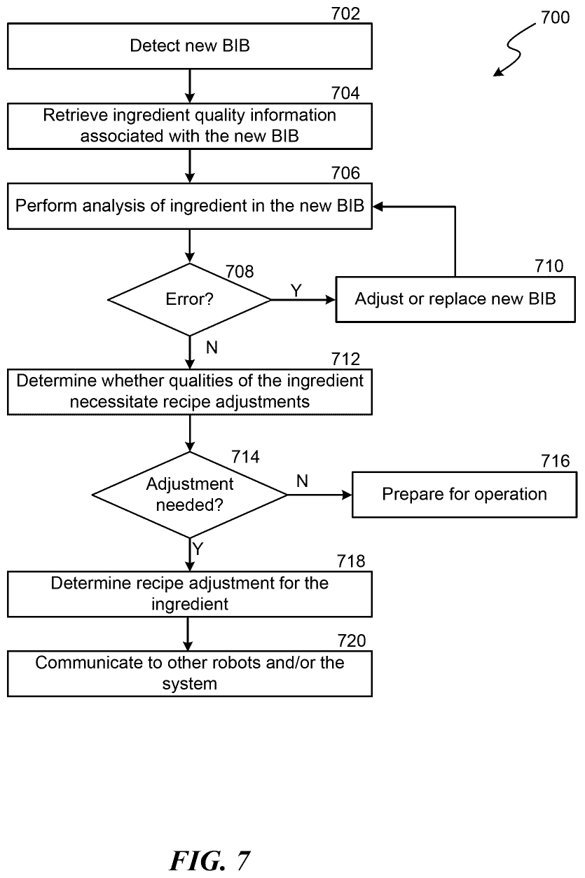

As discussed in more detail below, for example, embodiments of the present technology include processes related to operating a beverage robot at a vending location. The process can include analyzing ingredients used by the beverage robot to identify variances in the ingredient quality between different ingredient packages and/or over time. For example, the process can also include determining the acidity, sweetness, and/or concentration levels of the ingredients and determining if any of the ingredients are expired. Additionally, the process can also include adjusting the recipe for one or more beverages based on the determined acidity, sweetness, and/or concentration levels of the ingredients to improve a consistency in flavor profiles of the resulting beverages across different lots of ingredients. Although beverage robots are primarily discussed herein, one of skill in the art will understand that the scope of the invention is not so limited. Purely by way of example, the methods disclosed with respect to FIGS. 7-9 can also be used to analyze ingredients and manage orders from one or more food robots in addition to (or instead of) one or more beverage robots.

Conventional beverage restaurants, cafés, coffee shops, tea shops, and/or the like encounter challenges in maintaining a consistent flavor profile for beverages due to inconsistencies of the ingredients. Over time, ingredients can become acidic, sweet, or bland, which results in a degradation of quality. For example, the acidity of coffee can vary between batches of coffee without a vendor being aware. The variance in acidity can result in customer dissatisfaction with the taste of various coffee-based beverages. Additionally, or alternatively, when a customer drinks the acidic coffee, they can become ill. As a result of either outcome, the customer may not purchase from the vendor in the future. To help address these issues, the systems and methods disclosed herein provide one or more beverage robots to the vending locations. Each of the beverage robots can store a variety of ingredients required to prepare a variety of beverages offered at the vending location. The beverage robots can help increase a consistency in the beverages served at the vending location, helping to improve customer satisfaction.

The implementation of the beverage robots, however, creates numerous technical challenges. For example, while providing differing ingredients in different beverage robots can help expand the range of beverages that can be prepared at the vending location, the differing ingredients can cause one or more of the beverage robots to be unable to prepare one or more of the beverages offered. Further, the network must distribute the orders (or individual beverages in the orders) to help produce the orders efficiently, reduce (or avoid) downtime in a subset of the beverage robots while other robots have a backlog of orders; and/or to account for downtime required to refresh the stock of ingredients, clean the beverage robots, and/or maintain the beverage robots. Still further, variations in ingredient packages (e.g., beverage-in-boxes (BIBs)) can reduce consistency in the beverages produced by the beverage robots. Purely by way of example, different coffee batches can have varying amounts of acidity (creating varying amounts of bitterness) that produce differences in a beverage prepared according to a recipe. Relatedly, ingredient qualities can drift over time while ingredients are stored on a shelf and/or installed in a robot. Purely by way of example, the acidity of an ingredient can increase (or decrease) during its shelf life, which can affect the flavor profile of the ingredient, as well as any beverage prepared using the ingredient.

Tests can be performed to the ingredients to identify when a change occurs in the ingredient quality. When changes are identified, the systems and methods disclosed herein can dynamically adjust recipes that will be used to produce the order. Purely by way of example, the systems and methods disclosed herein can perform a test to determine if the sweetness or acidity levels of an ingredient have changed and adjust a recipe for a beverage based on a determined acidity or sweetness level (e.g., brix value) of an ingredient in the recipe. As a result, the beverages can taste fresher and maintain a consistent flavor profile for a customer. Additionally, or alternatively, beverage robots can allow the vending locations to offer a wider variety of beverages to their customers, especially when a network of multiple beverage robots with different ingredients is implemented in the vending location.

To overcome these technical deficiencies, the systems and methods disclosed herein include various processes for assigning and managing orders throughout their production. For example, the network of beverage robots can include a primary robot that is in communication with a point-of-sale (POS) system and one or more secondary robots. The primary robot can receive an order from the POS system, retrieve recipes associated with each beverage in the order, and identify the required ingredients for each beverage based on the recipes. The primary robot can then identify, for each beverage in the order, one or more eligible robots that have access to the ingredients required to make the beverage, check the queue at each of the eligible robots, and assign the beverage based on the queue and various time-related parameters. As a result, the primary robot can ensure that beverages are only assigned to beverage robots that have access to the ingredients required to make them. Further, the primary robot can help manage the distribution of beverages among the beverage robots to reduce (or avoid) downtime in the network while one or more beverage robots have a long backlog. Still further, by considering the time-related parameters, the primary robot can help ensure that drinks are prepared as needed (e.g., immediately, closer to a pick-up time, when other items in an order are ready, and/or the like).

### Examples of Suitable Systems for Operating Food and/or Beverage Robots in Accordance With Embodiments of the Present Technology

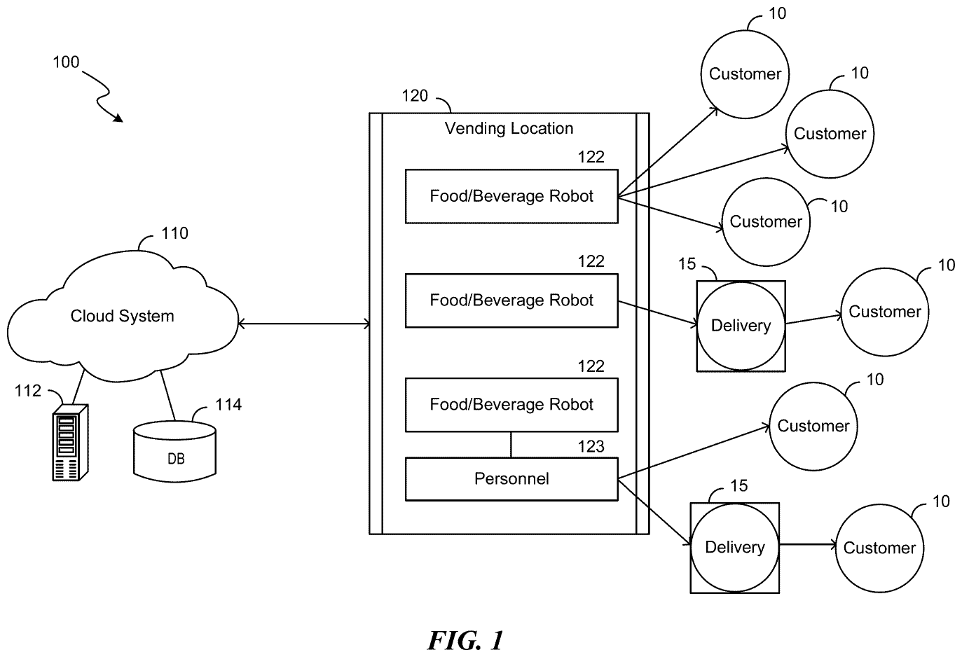

FIG. 1 is a schematic diagram of a system 100 for operating food and/or beverage robots in accordance with some embodiments of the present technology. The system 100 can interconnect a remote system 110 with one or more vending locations 120 (one illustrated in FIG. 1) to operate one or more food/beverage robots 122 (three illustrated in FIG. 1) at each of the vending location(s) 120. As discussed in more detail below, the food/beverage robots 122 can automate the preparation of various food items and/or beverages for customers 10 at the vending location(s) 120. The automation, in turn, can allow the vending location(s) 120 to provide a wider variety of food items and/or beverages, increase the number of the customers 10 the vending location(s) 120 can serve, improve consistency in the taste of the food items and/or beverages, and/or increase transparency into a status of an order and/or an estimated completion time for the order.

As illustrated in FIG. 1, the remote system 110 can include one or more servers 112 (one illustrated in FIG. 1) as well as one or more databases 114 (one illustrated in FIG. 1). The server(s) 112 can be an edge server and/or a cloud-based server with one or more server computing devices configured to perform various operations in support of the food/beverage robots 122. Purely by way of example, as discussed in more detail below, the server(s) 112 can manage orders for food/beverages, queue orders between different sets of the food/beverage robots 122 and/or between different vending location(s) 120, manage and/or monitor food/beverage ingredients, monitor the operation of the food/beverage robots 122 (e.g., check cleaning status, monitor for part malfunctions, predict and/or schedule maintenance, and/or the like), maintain and/or share food/beverage recipes, modify recipes to account for variances in ingredients, and/or the like. The server(s) 112 can include various hardware, such as processing units (e.g., GPUs, CPUs, APUs, and/or the like), working memory, storage memory, input/output devices, displays (e.g., LCD display screens, LED display screens, OLED display screens, and/or the like), a network card, video card, audio card, USB ports, and/or the like. Further, the server(s) 112 are illustrated as a single server, the server(s) 112 can each be a distributed computing environment encompassing multiple computing devices located at the same or at geographically disparate physical locations. Further, the server(s) 112 can correspond to a group of servers supporting the food/beverage robots 122.

The database(s) 114 can warehouse (e.g., store) information, such as drink recipes, lot information or ingredients, stocking keeping units (SKU) information, part information, and/or the like. Though database(s) 114 is illustrated as a single unit, the database(s) 114 can each be a distributed computing environment encompassing multiple computing devices, can be located within one of the server(s) 112 (and/or within a computing device of the server(s) 112), or can be located at the same or at geographically disparate physical locations. The database(s) 114 can include one or more memories, each of which can include various hardware devices for volatile and non-volatile storage. For example, the memory can comprise random access memory (RAM), various caches, CPU registers, read-only memory (ROM), and writable non-volatile memory, such as flash memory, hard drives, CDs, flash drives, magnetic storage devices, and/or the like. The memory is not a propagating signal divorced from underlying hardware; the memory is thus non-transitory. Further, the memory can include sections, such as a program memory section that stores programs and software related to the operation of the food/beverage robots 122 and/or a data memory section that stores data related to the operation of the food/beverage robots 122.

The remote system 110 can be communicatively coupled to various computing devices at the vending location(s) 120 through a network connection (e.g., an internet connection, cellular network, and/or the like). For example, the communication can be implemented through the network using TCP/IP protocols, a Q-LAN protocol, or others. In a specific, non-limiting example, each of the food/beverage robots 122 can include computing components that allow the food/beverage robots 122 to communicate individually (or collectively) with the remote system 110 and/or various other computing devices at the vending location(s) 120 (e.g., point-of-sale systems, on-site servers, and/or the like).

As discussed in more detail below, the communication can allow the remote system 110 to support and/or control (partially or fully) various operations of the food/beverage robots 122 and/or various related operations. For example, the vending location(s) 120 can be any location that serves food items and/or beverages (e.g., a store, café, coffee shop, tea shop, restaurant, food truck, brewery, bar, hotel, resort, conference center, stadium, entertainment center (e.g., a theater, music venue, arcade, bowling center, pool hall, theme park, and/or the like), and/or any other suitable location). The remote system 110 can communicate with the food/beverage robots 122 in the vending location(s) 120 to store and/or communicate recipes for orders; monitor ingredients available at the food/beverage robots 122; assign orders (or portions thereof) to the food/beverage robots 122; time the completion of orders based on other aspects of the order, a location of the customers 10, a location of a delivery person, and/or the like; monitor a cleaning and/or health status of the food/beverage robots 122; and/or any other suitable operation.

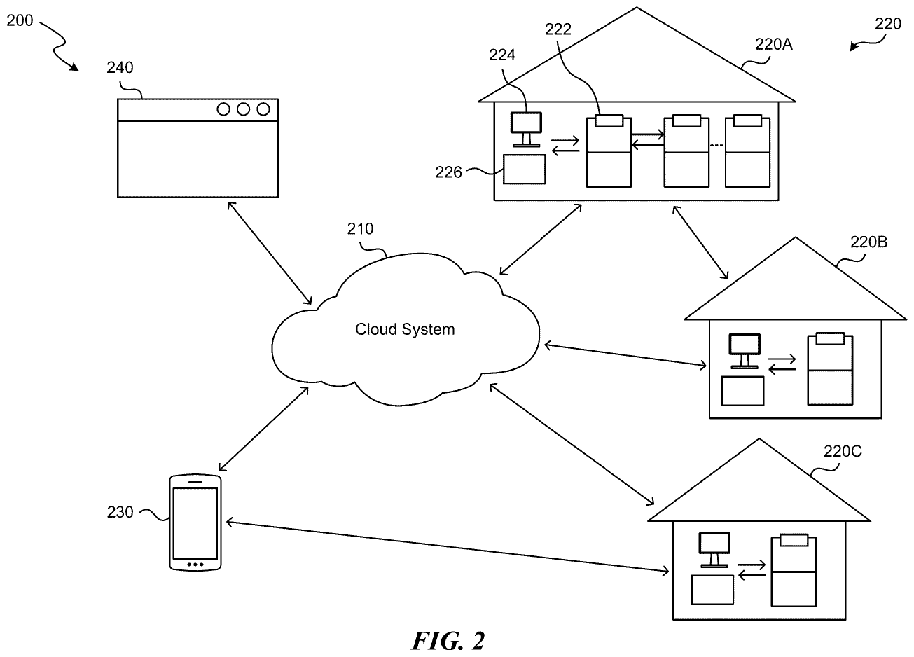

FIG. 2 is a schematic network diagram of an environment in which embodiments of the present technology can operate. The environment can include a remote system 210 (e.g., a cloud computing system) generally similar (or identical) to the remote system 110 discussed above with respect to FIG. 1. For example, the remote system 210 can include one or more servers (e.g., the servers of FIG. 1) as well as one or more databases (e.g., the databases 114 of FIG. 1) that allow the remote system 210 to support and/or facilitate various operations in the environment 200. As further illustrated in FIG. 2, the environment 200 can also include one or more vending locations 220 (three illustrated in FIG. 2, referred to individually as first-third vending locations 220A-220C), one or more client computing devices 230 (one illustrated in FIG. 2), and one or more third-party platforms 240 (one illustrated in FIG. 2). As further illustrated in FIG. 2, the vending locations 220, client computing devices 230, and third-party platforms 240 are each communicatively coupled to the remote system 210 (e.g., via a network connection). As a result, as discussed in more detail below, the remote system 210 can help support, facilitate, and/or control operations at each of the vending locations 220, the client computing devices 230, and/or the third-party platforms 240. Additionally, or alternatively, the remote system 210 can provide a connection and/or facilitate communications between the vending locations 220, the client computing devices 230, and/or the third-party platforms 240.

Similar to the discussion above, the vending locations 220 can include any location providing food and/or beverage sales to customers. In a non-limiting example, the first vending location 220A can be a restaurant, the second vending location 220B can be a food truck, and the third vending location 220C can be a coffee shop. Further, each of the vending locations 220 can include one or more food/beverage robots 222, a point-of-sale (POS) system 224, and/or an onsite computing system 226. The food/beverage robots 222, the POS system 224, and the onsite computing system 226 can be communicably coupled by a network (e.g., the internet, a local area network (LAN), a wide area network (WAN), and/or the like), one or more wired connections, and/or various shortrange wireless communication components (e.g., Bluetooth®, Zigbee®, Z-Wave®, HaLow®, Wi-Fi, NearLink, near-field communication (NFC), low-power WAN, ultra-wideband (UWB), and/or the like). As a result, the food/beverage robots 222, the POS system 224, and the onsite computing system 226 can help partially (or fully) automate transactions and the production of orders received at each of the vending locations 220.

For example, as discussed in more detail below, the food/beverage robots 222 can store and/or have access to any suitable number of ingredients and automate the preparation of various food items and/or beverages. Purely by way of example, the food/beverage robots 222 can store a plurality of bag-in-boxes (BIBs) that each has concentrated ingredients for various different beverages (e.g., juice blends, sodas, teas, boba drinks, coffee drinks, energy drinks, matés, milk drinks, milkshakes, lemonades, flavored water, flavored sparkling water, mocktails, probiotic drinks, and/or the like). The food/beverage robots 222 can access one or more of the BIBs in response to an order and automatically mix the ingredients to prepare one or more beverages in the order. The POS system 224 can include various devices to receive and process transactions and generate orders for the food/beverage robots 222. For example, the POS system 224 can include cash registers, electronic terminals (e.g., touchscreen terminals), virtual terminals (e.g., accessible through an app on a customer's phone, a web browser, and/or the like), credit card readers, chip readers, and/or the like. Once a transaction is processed, for example, the POS system 224 can send the order(s) associated with the transaction to the food/beverage robots 222 to be prepared. The onsite computing system 226 can include desktop computers, laptops, server computing devices, databases and other storage devices, and/or the like to provide computational services (e.g., order processing, order distribution, order management, order change requests, recipe management, ingredient management, maintenance scheduling, cleaning scheduling, quality control, and/or the like) for the POS system 224 and/or the food/beverage robots 222. Said another way, the onsite computing system 226 can provide local services that support the operations discussed herein as additional, or peripheral, computing devices to the remote system 210.

The client computing devices 230 can include wireless smartphones, wireless tablets, desktop computers and other computer systems (e.g., server computers), wireless laptops, digital assistants, virtual assistants, other smart devices (e.g., smart watches, smart glasses, and/or the like), internet-of-things (IoT) devices, and/or the like. The client computing devices 230 allow users (e.g., customers, vending location staff and/or personnel, maintenance personnel, brand personnel, and/or the like) to access different components of the environment 200. For example, a customer can access the remote system 210 and/or the POS system 224 in any of the vending locations 220 through their smartphone to place an order. In another example, a manager at one of the vending locations 220 can access the remote system 210 and/or the food/beverage robots 222, the POS system 224, and/or the onsite computing system 226 through a laptop computer to monitor information on the vending locations 220 (e.g., stock levels for the ingredients, maintenance warnings/schedules, cleaning schedules, order history, order trends, and/or the like).

The third-party platforms 240 can be implemented on various suitable computing devices and/or systems (e.g., server computing systems, laptop computers, desktop computers, smart devices, and/or the like). The third-party platforms 240 can provide peripheral services to the remote system 210 and/or any of the other components in the environment 200. Purely by way of example, the third-party systems can include a sales, marketing, and deployment tracking platform (e.g., ClickUp and/or the like) that helps the remote system 210 monitor the deployment of the food/beverage robots 222, sales across the environment 200, and/or the like. Additionally, or alternatively, the sales, marketing, and deployment tracking platform can help any of the vending locations 220 monitor the deployment of the food/beverage robots 222, track their sales, market their food/beverage options, and/or the like.

In another example, the third-party platforms 240 can include a data visualization and analytics platform (e.g., Tableau, Looker, and/or the like). The data visualization and analytics platform can work with raw data from the remote system 210 and/or any of the vending locations 220 (or any specific components therein) to summarize and/or analyze the data. In a specific, non-limiting example, the data visualization and analytics platform can identify sales trends in the data for the remote system 210, allowing the remote system 210 to make recommendations to the vending locations 220 on what ingredients to stock, popular recipe trends, recipes trends specific to the vending location area and/or type, and/or the like. Additionally, or alternatively, the data visualization and analytics platform can record data on needed maintenance, maintenance schedules, cleaning schedules, and/or the like to help the remote system 210 and/or the vending locations 220 track the status of the food/beverage robots 222.

In yet another example, the third-party platforms 240 can include a customer support platform (e.g., Freshdesk and/or the like). The customer support platform can supplement (or provide) a service dashboard in the remote system 210 to help the remote system 210 provide services to the vending locations 220. In a specific, non-limiting example, the customer support platform can use the raw data (and/or analyses from the data visualization and analytics platform) to respond to calls from the vending locations 220 regarding the status of the food/beverage robots 222. Further, the customer support platform can help proactively monitor and manage the health of the food/beverage robots 222 (e.g., using data from the data visualization and analytics platform to schedule maintenance ahead of a breakdown). Additionally, or alternatively, the vending locations 220 can be connected to the customer support platform through the remote system 210 to provide customer support at the vending locations (e.g., answer questions about transactions, complaints about orders, suggestions for the vending locations 220, issue refunds, and/or the like).

In yet another example, the third-party platforms 240 can include an enterprise resource planning (ERP) platform. The ERP platform can help the remote system 210 and/or the vending locations 220 manage invoices, orders, inventory, and/or the like. In a specific, non-limiting example, the remote system 210 can be integrated with the ERP platform to track SKU information on the ingredients used in each of the food/beverage robots 222 to alert the vending locations 220 and/or automatically order additional inventory when the ingredients are low. Additionally, or alternatively, the vending locations 220 can access the ERP platform to help track the invoices associated with ingredients they order, and/or the like.

In yet another example, the third-party platforms 240 can include a third-party logistics (3PL) platform (e.g., Logiwa). The 3PL platform can help the remote system 210 manage warehouse and shipping logistics to provide and/or install the food/beverage robots 222 in the vending locations 220, provide and/or install parts for the food/beverage robots 222, provide ingredients for the vending locations 220, and/or the like. Additionally, or alternatively, the 3PL platform can help the remote system 210 manage various special orders (e.g., modifications to customize the food/beverage robots 222 to any of the vending locations 220, customized ingredient orders, and/or the like) from the vending locations 220.

Although discussed above as being connected through the remote system 210, the vending locations 220, the client computing devices 230, and/or the third-party platforms 240 can communicate directly. For example, as illustrated in FIG. 2, the first vending location 220A can directly communicate with the second vending location 220B. The direct communication can allow, for example, the first and second vending locations 220A, 220B to share orders (or portions thereof) independent from control and/or supervision from the remote system 210. The direct communication and independent control, in turn, can reduce the resources required in the remote system 210 to support the operation of the first and second vending locations 220A, 220B. In another example, the client computing device 230 can communicate directly with the third vending location 220C. The direct communication can allow, for example, the third vending location 220C to receive order(s) directly from the client computing device 230, without any delays relaying the order through the remote system 210.

Further, although the vending locations 220 are illustrated in FIG. 2 as each having at least one of the food/beverage robots 222, the POS system 224, and the onsite computing system 226, it will be understood that the systems and methods disclosed herein are not so limited. For example, any of the vending locations 220 can omit the food/beverage robots 222 and instead communicate with another of the vending locations 220 (directly or through the remote server) to produce orders. In another example, any of the vending locations 220 can omit the POS system 224 and/or the onsite computing system 226. Instead, the remote system 210 can receive, distribute, manage, and/or track orders on behalf of the vending locations 220 and/or provide any necessary computational services.

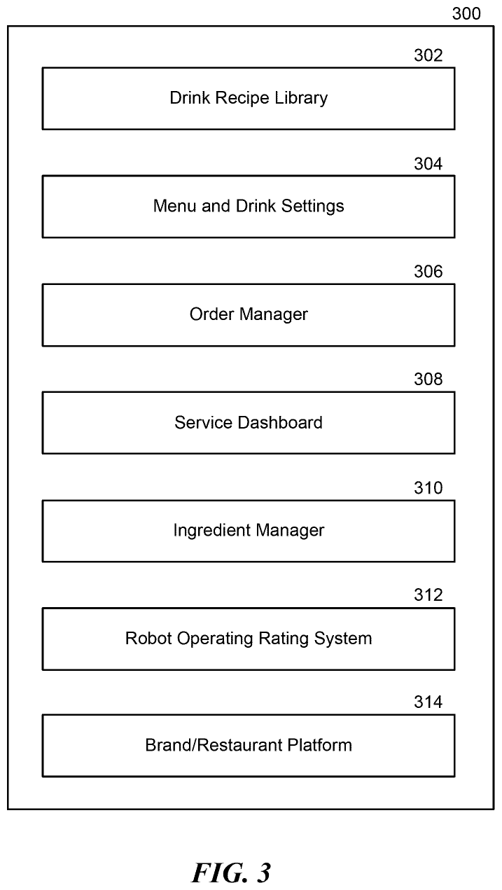

FIG. 3 is a block diagram of a platform 300 for operating a network of beverage robots in accordance with some embodiments of the present technology. The platform 300 can be implemented in one or more computing devices, such as the remote system 210 discussed above with reference to FIG. 2, to help support, manage, and/or control operations in a variety of vending locations. For example, the platform 300 can be implemented on one or more processors of a computing system with access to any suitable number of storage components to facilitate the operations of the platform 300 as described herein. Further, as illustrated in FIG. 3, the platform 300 can include one or more modules (seven illustrated in FIG. 3, referred to individually as first-seventh modules 302-314), various examples of which are discussed in more detail below.

The first module 302 can include a drink recipe library. The drink recipe library can include information on the proportions of ingredients for a variety of beverages, such as juice blends, sodas, teas, boba drinks, coffee drinks, energy drinks, matés, milk drinks, milkshakes, lemonades, flavored water, flavored sparkling water, mocktails, probiotic drinks, and/or the like. In some embodiments, the recipes include specific ratios (e.g., percentages of different ingredients such as 5% a first juice, 5% a second juice, 1% simple syrup, 40% ice, and 39% water; ratios of ingredients such as 1 part tea concentrate, 0.5 parts ice, 1 part water; and/or the like). Additionally, or alternatively, the recipes can include various nutrient tables, acidity information, sweetness information, concentration information, and/or the like related to how a beverage should taste. In such embodiments, the drink recipe library can allow beverage robots to vary the exact ratios of ingredients to account for variations in the ingredients (e.g., using more or less of a juice concentrate based on variations in different batches, using more or less simple syrup to compensate for variations in the acidity of batches of coffee concentrate, and/or the like). Further, the drink recipe library can have recipes that allow beverage robots to produce beverages of any size, beverages in a range of sizes (e.g., common sizes such as 16 ounces (oz), 20 oz, 24 oz, and/or the like), and/or only beverages of a specified size (e.g., 16 oz of an energy drink to limit the caffeine provided in a single beverage).

Still further, the drink recipe library in the first module 302 can include a variety of generic recipes, a list of previously customized recipes, branded recipes, and/or the like. The generic recipes can be baseline recipe suggestions for a variety of drinks that a vending location can customize based on taste preferences and/or customer feedback. Any customized recipe can then be stored to be accessed, used, and/or customized by other vending locations. The branded recipes can be specific to drink and/or beverage brands (e.g., juice brands, sports drink brands, coffee brands, tea brands, soda brands, energy drink brands, health drink brands, smoothie brands, milkshake brands, and/or the like) and/or specific to vending locations (e.g., specific to stores of a specific a franchise name). The first module 302 (and/or a related module) can advertise the availability of the branded drinks but restrict access to the recipes until approved by the brand. For example, the first module 302 can require a vending location to pay an upfront fee and/or royalties to access a branded recipe. In another example, the first module 302 can allow a brand to review an access request to control where their branded drinks are available and/or check for quality control at the vending locations requesting access. Additionally, or alternatively, the first module 302 can monitor customized recipes for imitations of branded recipes to help prevent vending locations from copying branded drinks after accessing them once.

The second module 304 can help generate menu and drink settings for a vending location. For example, the second module 304 can keep track of the required ingredients for recipes as a vending location builds a menu, prevent the vending location from selecting recipes requiring additional ingredients once they reach a limit on the ingredients the beverage robots can store, and/or suggest additional beverages based on the ingredients at the vending location (e.g., other beverages that can be created without additional ingredients). Additionally, or alternatively, the second module 304 can use information about the vending location (e.g., restaurant type, sales in a surrounding area, demographic information around the vending location, seasonal information, and/or the like) to suggest recipes for the menu. Purely by way of example, the second module 304 can recommend that a pizza restaurant stock ingredients for lemonade, sodas, sports drinks, and/or the like based on those beverages typically selling well with pizza. In another example, the second module 304 can recommend a vending location near a university to stock ingredients for coffee, energy drinks, and/or the like based on demographic information for the vending location. Still further, once a vending location has selected recipes for their beverage robot(s), the second module 304 can generate a menu (e.g., a user interface for a virtual menu) with the recipes and provide the menu to the vending location POS and/or the beverage robot.

The third module 306 can provide an order manager to one or more vending locations. The order manager can queue orders (or individual beverages from orders) to be produced by the beverage robot(s). For example, the order manager can determine which beverage robot in a café will be able to produce an order fastest based on existing queues at each beverage robot in the café, then add the order to the queue at the chosen beverage robot. In some embodiments, orders are scheduled based on estimated completion times and estimated pick-up times. For example, when a customer orders through an app on their phone, the order manager can estimate when they will arrive at the café and delay the production of their order until closer to the arrival time. As a result, the order will be fresher when picked up than if the order had been queued and produced when received. In another example, the order manager can receive a take-out/delivery order for a beverage from a first restaurant, determine that a second restaurant can provide the beverage to the customer sooner, and present the customer with the option to receive the beverage from the second restaurant. By producing the order from a recipe with a beverage robot, the customer can then receive the same drink (as customized to the first restaurant) from the second restaurant. Further, the first and second restaurants can expand their sales by making the beverages more convenient/quicker to receive. In yet another example, the order manager can track the status of an order throughout the production process (e.g., by monitoring the position in the queue(s)) to provide customers with a real-time, accurate prediction of when their order will be complete. The increased transparency can increase customer satisfaction, particularly during busy times at a vending location. In yet another example, the order manager can receive customizations and/or order changes. Further, because the order manager can track the status of an order through production, the order manager can allow a customer to seamlessly make changes to their order until the order is prepared by the beverage robot(s).

The fourth module 308 can provide a service dashboard for vending location personnel and/or personnel associated with the beverage robots. The service dashboard can provide a record of statistics and data from the beverage robots (e.g., past and scheduled maintenance, health status of beverage robots, cleaning status of beverage robots, usage of beverage robots, and/or the like). In a specific, non-limiting example, the service dashboard can show that one or more tubes in a beverage robot are locked, along with an error code explaining why they are locked (e.g., spoiled ingredients, required cleaning, connection malfunction, and/or the like). As a result, the service dashboard can allow personnel associated with the beverage robots to respond to inquiries from vending locations and/or guide them through correcting the error. Additionally, or alternatively, the service dashboard can allow vending location personnel to address issues without contact with other maintenance personnel. In some embodiments, the service dashboard in the fourth module 308 can communicate with one or more additional modules (e.g., the sixth module 312 discussed in more detail below) to provide information related to the health status of beverage robots, cleaning data related to the beverage robots, usage of the beverage robots, and/or the like.

The fifth module 310 can include an ingredient manager. The ingredient manager can receive SKU information for shipments to vending locations and ingredient packages (e.g., BIBs) as they are used by the beverage robots. The ingredient manager can use the SKU information to track ingredient consumption in vending locations. Additionally, or alternatively, the ingredient manager can track and/or identify ingredients from specific batches (e.g., to prompt the first module 302 to adjust a recipe for variations between batches, identify recalled batches, and/or the like). Further, the ingredient manager can track ingredient expiration dates (e.g., milk and other spoilable ingredients) and prompt vending locations to replace ingredients close to their expiration. Still further, the ingredient manager can receive information from one or more sensors in the beverage robots related to ingredients remaining in a package (e.g., dispensing information, weight measurements, volume measurements, and/or the like) to help track and manage inventory for a vending location. The ingredient manager can then prompt a vending location to replace (or plan to replace) empty packages in the beverage robots, order more packages as their inventory goes down, and/or the like. In some embodiments, the ingredient manager automatically manages inventory (e.g., tracks and orders inventory) for a vending location to make sure they are stocked on ingredients. In some such embodiments, the ingredient manager accounts for sales trends, sales forecasts, and/or the like while managing inventory. Purely by way of example, the ingredient manager can stock additional ingredients for cold beverages ahead of a heat wave in anticipation of increased sales to make sure the vending location has adequate inventory.

The sixth module 312 includes a robot operating rating system. The robot operating rating system can use data from beverage robots at a vending location to evaluate and/or grade the vending location. For example, the robot operating rating system can consider data related to cleaning cycles and cleaning times of the beverage robots, error codes and responses to error codes, employee certification and training, inventory management from vending locations, shelf-life management from vending locations, and/or the like. The data can then be used to generate food safety ratings, grade the operation of the beverage robots, improve quality control for the operation of the beverage robots, and/or the like. The sixth module 312 can then use the ratings to adjust maintenance schedules for the beverage robots (e.g., increase maintenance when vending locations do not respond well to error codes), adjust the operation of the beverage robots (e.g., prevent robots from dispensing spoiled ingredients), and/or provide the ratings to franchise owners and/or brands to help monitor the vending locations for quality control.

The seventh module 314 can provide a platform for brands/vending locations to market themselves and/or interact. For example, brands can create beverage recipes that they market through the seventh module. Vending locations can review available brands as they generate (or refresh) their menu offerings, then contract with the brands through the seventh module 314. Additionally, or alternatively, brands can contact vending locations through the seventh module to place their beverages in a variety of locations. Further, the seventh module 314 can communicate with various other modules on the platform 300. Purely by way of example, the seventh module 314 can communicate with the sixth module 312 to make ratings of vending locations available to brands as they decide whether to contract with a vending location. Similarly, the seventh module 314 can obtain sales data associated with branded drinks to provide the sales data to vending locations as they decide whether to work with a brand. As a result, the seventh module 314 can help increase transparency between brands and vending locations, increase quality control for branded beverages, and/or the like.

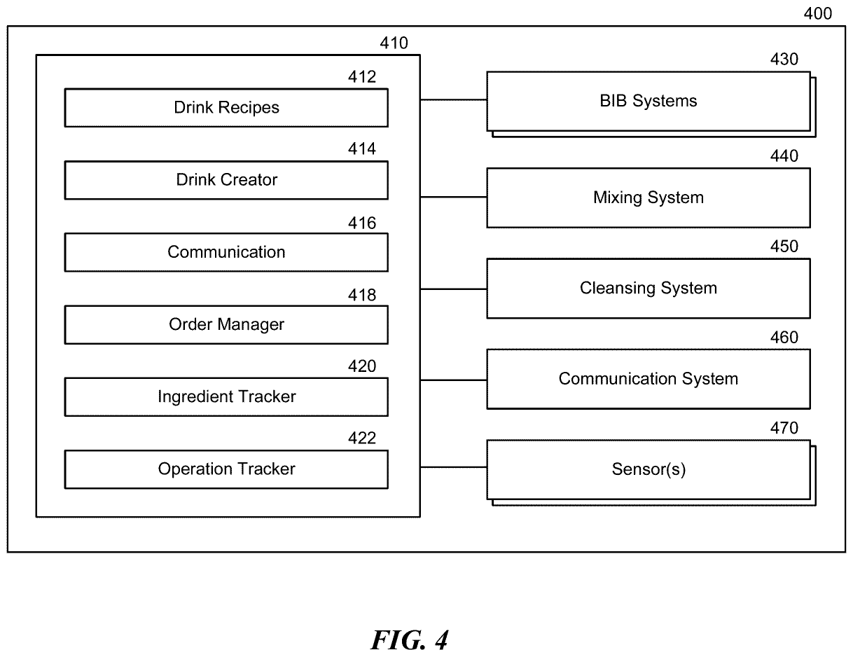

FIG. 4 is a block diagram of a subsystem 400 for a beverage robot in accordance with some embodiments of the present technology. The subsystem 400 can be deployed, for example, in the food/beverage robots 222 discussed above with respect to the environment 200 of FIG. 2. A processor and/or a storage component are not illustrated in FIG. 4 to avoid obscuring the illustrated components of the subsystem 400. However, one of skill in the art will understand that the subsystem 400 can include one or more processors and any suitable number of storage components to facilitate various operations of the subsystem 400 described herein.

As illustrated in FIG. 4, the subsystem 400 includes an operating platform 410 (“platform 410”) with one or more modules (six shown, referred to individually as first-sixth modules 412-422), as well as one or more BIB systems 430 (and/or other suitable ingredient containers), a mixing system 440, a cleansing system 450, a communication system 460, and one or more sensors 470.

The BIB systems 430 can store various concentrated ingredients related to beverage offerings from the subsystem 400. The mixing system 440 can receive and mix ingredients from the BIB systems 430 according to a recipe in a relatively short time (e.g., in less than a minute per beverage, less than 40 seconds per beverage, less than 30 seconds per beverage, and/or the like). In various embodiments, the mixing system 440 can include a blending component, shaking component, stirring component, emulsifying component, and/or any other suitable system to mix the ingredients according to the recipe. The cleansing system 450 can clean the mixing system 440, and/or any tubing and/or valves between the BIB systems 430 and the mixing system 440. The cleansing system 450 can be configured to operate between each beverage to avoid flavor contamination between beverages. Additionally, or alternatively, the cleansing system 450 can operate periodically to kill bacteria and/or build up in the tubing and/or valves.

The communication system 460 can operably couple the subsystem 400 to various other subsystems and/or platforms, such as other beverage robots, the POS system 224 of FIG. 2, and/or the platform 300 of FIG. 3. In various embodiments, the communication system 460 can include components configured to communicate over a shortrange wireless standard (e.g., a Bluetooth®, Zigbee®, Z-Wave®, Wi-Fi HaLow®, or any other suitable shortrange standard), communicate with a network over a wireless (or wired) internet connection (e.g., a WiFi connection or ethernet connection), and/or communicate with the network through a cellular internet connection (e.g., based on a 3G, 4G, LTE, 5G, 6G, or other standard).

The sensors 470 can be coupled to various components of the subsystem 400 to help monitor the operation of the beverage robot. For example, the sensors can include weight and/or volume sensors coupled to the BIB systems 430 to measure remaining ingredients in each BIB; temperature sensors in the BIB systems 430 to help monitor a freshness and/or status of ingredients; volumetric dispensing sensors to monitor the volume of ingredients provided to the mixing system 440; operating sensors coupled to the cleansing system 450 to monitor a frequency of cleansing; and/or the like. Additionally, or alternatively, the sensors 470 can include sensors that monitor connections between the BIB systems 430 and the mixing system 440 to make sure tubes, valves, and/or nozzles are properly connected and in good health; and/or other sensors to monitor a health condition of the beverage robot.

The platform 410 can be operably coupled to each of the BIB systems 430, the mixing system 440, the cleansing system 450, the communication system 460, and/or the sensors 470 to facilitate various operations of the beverage robot via the first-sixth modules 412-422 (and/or any other suitable modules). For example, the first module 412 can store drink recipes specific to the beverage robot, access the drink recipe library in the first module 302 of FIG. 3, and share drink recipes with other beverage robots (e.g., to allow the other beverage robots to prepare the recipe) and/or receive recipes from other beverage robots. Further, the first module 412 can communicate with a POS system and/or other user interface to share information on the beverages available in the subsystem 400.

The second module 414 includes a drink creator. The drink creator can allow a vending location to customize a drink recipe from the first module 412 (e.g., adjusting the portions of ingredients, adding or removing ingredients, changing an order the ingredients are added/mixed, and/or the like). Accordingly, the drink creator can allow the vending location to customize generic recipes to preferences of the vending location. Additionally, or alternatively, the drink creator in the second module 44 can communicate with a POS system and/or other user interface to allow a user (e.g., a customer) to customize a beverage to their preferences (e.g., to change milk types, remove an ingredient, add an ingredient, and/or the like).

The third module 416 can include a communication manager. The communication manager can work with any of the modules in the platform 410 and/or any of the other components of the subsystem 400 to communicate outside of the subsystem 400. In a specific, non-limiting example, the communication manager can help direct communications between the first module 412 and a drink library in the remote system 210 of FIG. 2 to move drink recipes therebetween. In another specific, non-limiting example, the communication manager can send data from the sensors 470 to the robot operating rating system in the sixth module 312 discussed above with reference to FIG. 3.

The fourth module 418 can include an order manager. Similar to the order manager discussed above with reference to FIG. 3, the order manager can queue orders (or individual beverages from orders) to be produced by the beverage robot associated with the subsystem 400 and/or various other beverage robots in communication with the subsystem 400. For example, the order manager can queue orders at beverage robots with shorter wait times and the necessary ingredients. Additionally, or alternatively, the order manager can queue orders to sync estimated completion times with estimated pick-up times. In another example, the order manager can track the status of an order throughout the production process (e.g., by monitoring the position in the queue(s)) to provide customers with a real-time, accurate prediction of when their order will be complete. The increased transparency can increase customer satisfaction, particularly during busy times at a vending location. In yet another example, the order manager can receive order changes after an order is queued, modify the order in the queue, then produce the order. The on-site accessibility of the order manager can increase a speed of the order management and/or allow a vending location to override order queuing directly from the subsystem 400.

The fifth module 420 can include an ingredient tracker. Similar to the ingredient manager discussed above with reference to FIG. 3, the ingredient tracker can help monitor a volume of ingredients remaining in each of the BIB systems 430, track an age of the ingredients in the BIB systems 430, and/or the like. As a result, the ingredient tracker can notify a vending location when one of the BIB systems 430 needs to be replaced or will need to be replaced soon. Additionally, or alternatively, the ingredient tracker can help monitor overall volumes of ingredients used during a relevant time period to identify popular (or unpopular ingredients). The information can be useful, for example, in managing the vending location's inventory and orders related to various ingredients. Still further, the ingredient tracker can help identify ingredients approaching their expiration date, prompt the vending location to change the ingredients, and/or prevent the subsystem 400 from vending expired ingredients.

The sixth module 422 can include an operation tracker. The operation tracker can be communicably coupled to the order manager in the fourth module 418, the BIB systems 430, the mixing system 440, the sensors 470, and/or any other suitable components of the subsystem 400 to record operations thereof. As a result, the operation tracker can help track drink sales, identify cleaning and/or maintenance patterns, ensure the BIB systems 430 are properly installed, track how often the BIB systems 430 are swapped, whether the correct BIB systems 430 are swapped, whether the mixing system 440 is properly cleaned between orders, and/or the like. The information can be used by the vending location to help improve sales, identify popular (or unpopular) beverages, improve quality control, monitor staff operations, and/or the like. Additionally, or alternatively, the information can be used to schedule (or predict) maintenance for the beverage robot. Additionally, or alternatively, the information can be shared with an external system, such as the service dashboard and/or robot operating rating systems discussed above with reference to FIG. 3.

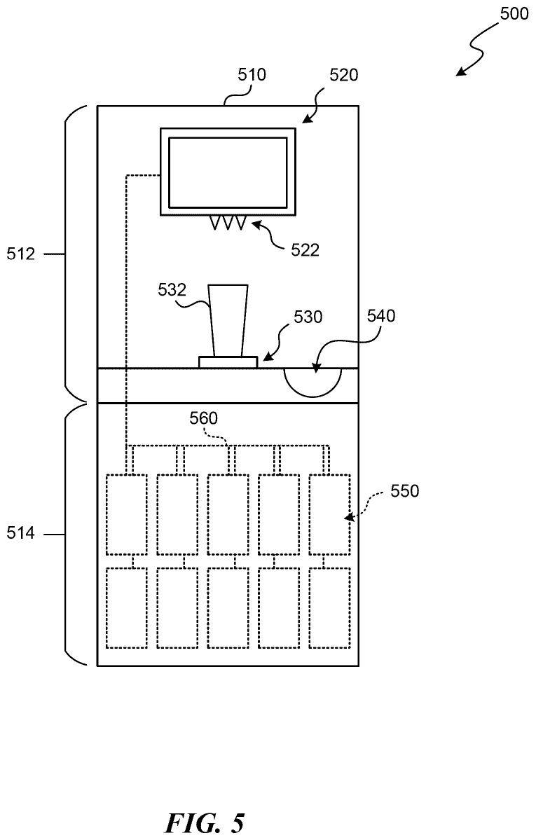

FIG. 5 is a schematic front view of a beverage robot 500 configured in accordance with some embodiments of the present technology. In the illustrated embodiment, the beverage robot 500 includes a housing 510 having an upper portion 512 and a lower portion 514 fluidly coupled to the upper portion 512. The upper portion 512 (sometimes also referred to as a “mixing portion,” an “active blending portion,” and/or the like) can include a dispensing head 520 positioned above a mixing driver 530 and a mixing container 532. The dispensing head 520 can include one or more nozzles 522 (three shown in the illustrated embodiment) that are positioned to dispense ingredients (e.g., concentrated juices, coffee, tea, syrups, water, sparkling water, and/or the like) into the mixing container 532. The mixing driver 530 can include a blender, shaker, emulsifier, and/or any other suitable component. The mixing container 532 can include a detachable container, an open container (e.g., an open cup), a closable container, and/or any other suitable component. As further illustrated in FIG. 5, the upper portion 512 can also include a cleansing system 540 adjacent to the mixing driver 530. The cleansing system 540 can include a glass rinser/washer that is configured to dispense water and/or a cleaning solution into the mixing container 532 and a draining component (e.g., a sink) to receive and carry used water and/or cleaning solution away from the mixing container 532. In some embodiments, the cleansing system 540 includes an automatic scrubber positioned to scrub the mixing container over the draining component.

During operation, the beverage robot 500 can dispense one or more ingredients through the dispensing head 520 and into the mixing container 532. The beverage robot 500 can then operate the mixing driver 530 to mix, blend, emulsify, and/or otherwise combine the ingredients in the mixing container 532. The beverage robot 500 can then repeat the process to dispense one or more additional ingredients and combine ingredients in the mixing container 532 according to a recipe for a current beverage. Additionally, or alternatively, the beverage robot 500 can dispense one or more ingredients to top the current beverage. A user of the beverage robot 500 (e.g., staff at a restaurant) can then pour the beverage out of the mixing container 532 into a container for the customer (e.g., a cup, disposable cup, bottle, carafe, bowl, and/or any other suitable container). Once empty, the user can position the mixing container 532 over the cleansing system 540 and operate the cleansing system 540 to clean and/or sanitize the mixing container 532. The user can then reset the mixing container 532 on the mixing driver 530 to prepare the beverage robot 500 for the next beverage.

As illustrated in FIG. 5, the lower portion (sometimes referred to as a “storage portion,” a “refrigeration portion,” and/or the like) can store one or more ingredient packages 550 (e.g., the BIB systems 430 discussed above with reference to FIG. 4). Each of the ingredient packages 550 can contain a concentrated ingredient that is used in one or more recipes that the beverage robot 500 can prepare. The ingredient packages 550 can be independently accessible and/or replaceable, allowing the user to swap packages as supply in any of the ingredient packages 550 runs low. In some embodiments, the lower portion 514 is refrigerated to keep the ingredient packages 550 at or below a predetermined temperature. In some embodiments, the lower portion 514 includes one or more sub-portions. A first sub-portion can be refrigerated to preserve perishable ingredients while a second sub-portion is not refrigerated (or heated) and stores non-perishable ingredients. The second sub-portion can be useful, for example, to store ingredients that become too viscous to adequately dispense when cooled.

As further illustrated in FIG. 5, each of the ingredient packages 550 can be fluidly coupled to the dispensing head 520 through vending lines 560. The vending lines 560 can include various components (e.g., valves, tubing connections, pumps, volumetric meters, pre-mixing components, and/or the like) to quickly provide ingredients to the dispensing head 520 with accurate volumetric amounts. In some embodiments, the vending lines 560 include a cleansing system configured to clean one or more of the tubing connections between beverages to reduce (or eliminate) cross-contamination. Further, in various embodiments, the lower portion 514 can be positioned directly beneath the upper portion 512 and/or can be separated from and fluidly coupled to the upper portion 512. In embodiments where the lower portion 514 is separated from the upper portion 512, the beverage robot 500 can include longer vending lines 560 and/or additional compression components to move ingredients between the lower portion 514 and the dispensing head 520.

### Specific Examples of Mesh Networks of Beverage Robots and Methods for Operating the Mesh Networks in Accordance With Embodiments of the Present Technology

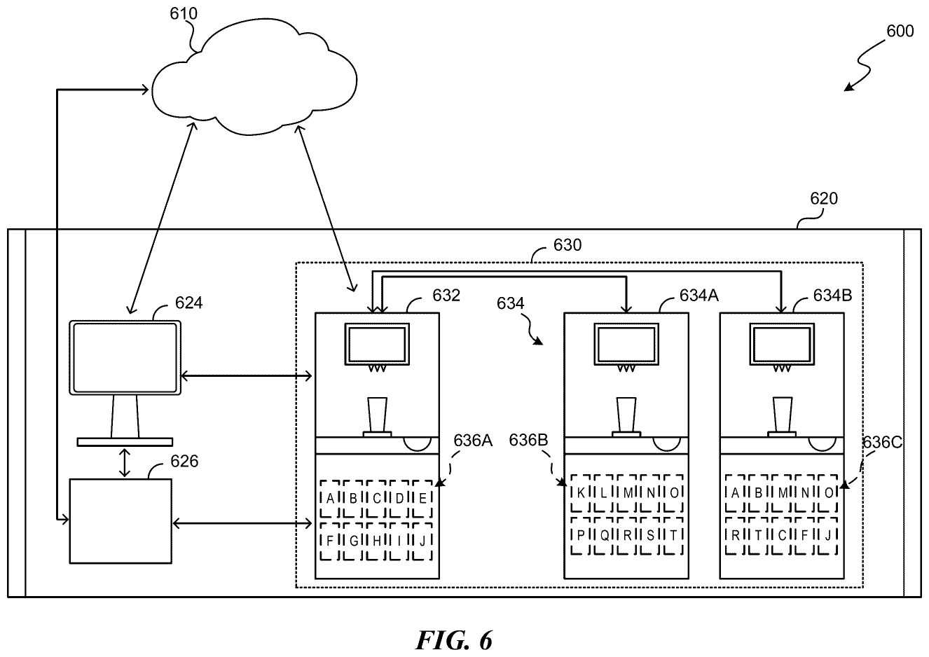

FIG. 6 is a schematic diagram of a mesh network 600 configured in accordance with some embodiments of the present technology. The mesh network 600 can allow a remote system 610 and/or a vending location 620 (e.g., any location that serves beverages) to monitor ingredient levels, analyze ingredient quality, receive orders, automatically adjust recipes for beverages in the orders based on the ingredient quality, automatically prepare the beverages in the orders, track the orders during production, and/or execute various related tasks. Further, while the mesh network 600 can communicate with the remote system 610 to produce and/or manage orders, the components of the vending location 620 discussed in more detail below can allow the vending location to execute most (or all) of the processes related to producing and/or managing orders independent from the remote system 610 and/or in conjunction with the remote system 610. For example, the components of the mesh network 600 can monitor ingredient levels at a beverage robot, determine if an ingredient for a beverage meets a quality threshold, receive an order requesting one or more beverages, and/or complete the order. In another example, the components of the mesh network 600 can adjust a recipe (e.g., a ratio of ingredients, ingredients used, and/or the like) for a beverage in the order to account for a change in quality of the ingredients. In yet another example, the components of the mesh network 600 can identify which beverage robots at the vending location 620 have the ingredients necessary to produce the order, and then analyze the quality of the ingredients available at the beverage robot. Additional examples of the functions of the components of the mesh network 600 are discussed below.

As illustrated in FIG. 6, the vending location 620 can include a POS system 624, an onsite computing system 626, and a network 630 of one or more beverage robots. The POS system 624 can be generally similar (or identical) to the POS system 224 discussed above with reference to FIG. 2. Purely by way of example, the POS system 224 can include an electronic register, a touchscreen device with a menu for the vending location 620, and/or the like. Similarly, the onsite computing system 626 can be generally similar (or identical) to the onsite computing system 226 discussed above with reference to FIG. 2. Purely by way of example, the onsite computing system 626 can include one or more onsite servers that provide a computational backbone for the vending location 620, provide additional storage for the vending location 620, and/or the like.

In the embodiment illustrated in FIG. 6, the network 630 includes three beverage robots. It will be understood, however, that the network 630 can include any other suitable number of beverage robots (e.g., one, two, three, five, ten, and/or any other suitable number of beverage robots). Any (or all) of the beverage robots in the network 630 can include a subsystem generally similar to the subsystem 400 discussed above with reference to FIG. 4 and/or can be generally similar to the beverage robot 500 discussed above with reference to FIG. 5. As a result, for example, each of the beverage robots in the network 630 can receive orders (or portions thereof) and/or automatically prepare beverages to produce the received orders. To help organize the production of orders, the network 630 can communicate with the remote system 610 and/or include designations for a primary robot 632 and two secondary robots 634 (referred to individually herein as a “first secondary robot 634A” and a “second secondary robot 634B”). The primary robot 632 (sometimes referred to herein as a “primary beverage robot,” a “leader robot,” and/or the like) can be communicably coupled to the remote system 610, the POS system 624, the onsite computing system 626, and each of the secondary robots 634 (sometimes also referred to herein as “secondary beverage robots,” “follower robots,” and/or the like). During operation, the primary robot 632 can receive orders (e.g., from the POS system 624, from the remote system 610, and/or the like), assign the orders (or portions thereof) among the beverage robots in the network 630, analyze various qualities of the ingredients provided by the chosen robot, make one or more changes to the recipe(s) associated with beverage(s) in the order, publish information related to the ingredients (e.g., a quality of an ingredient, a notification on a user interface, BIB error notifications, and/or the like), dynamically adjust recipe ratios of ingredients based on a quality of an ingredient in a BIB of each of the beverage robots in the network 630, and/or the like. For example, when a change in sweetness, acidity, flavor, and/or the like of an ingredient is detected, the network 630 of beverage robots can adjust the recipe for beverages to compensate for the changes (e.g., adjusting a ratio of ingredients, adding or subtracting ingredients, and/or the like). The adjusted recipe can help the mesh network 600 to maintain a consistent, high-quality drink for a customer to enjoy.

After receiving an order, the remote system 610 and/or the primary robot 632 can check the ingredients required for each beverage in the order (e.g., via an internal memory device, a query to the onsite computing system 626, one or more queries to the secondary robots 634, and/or the like). The remote system 610 and/or the primary robot 632 can then determine which of the beverage robots is eligible to prepare one or more beverages in the order based on the ingredients. Additionally, or alternatively, the primary robot 632 can check its own available ingredients and can query each of the secondary robots 634 to provide a record of their available ingredients. The check can be useful, for example, to confirm that the eligible robots have a sufficient volume of the ingredients available to prepare the beverage(s) in the order.

In the illustrated example, each of the beverage robots in the network 630 includes a different set of ingredients. For example, the primary robot 632 includes a first set of ingredients 636A with ingredients A-J (e.g., in BIB systems); the first secondary robot 634A includes a second set of ingredients 636B with ingredients K-T; and the second secondary robot 634B includes a third set of ingredients 636C with ingredients A-C, F, J, M-O, R, and T. The differences in the first-third sets of ingredients 636A-636C allow the beverage robots in the network 630 to prepare a larger variety of beverages than if each of the beverage robots had the same ingredients.

During operation, the primary robot 632 can assign the orders (or portions thereof) to beverage robots that have the ingredients required to make the orders. For example, after receiving an order, the primary robot 632 can check the ingredients required for each beverage in the order and then determine which of the beverage robots is eligible to prepare one or more beverages in the order based on the ingredients in the first-third sets of ingredients 636A-636C. The determination can be made from a record of the first-third sets of ingredients 636A-636C stored at the primary robot 632. The check can be useful, for example, to confirm that the eligible robots have a sufficient volume of the ingredients available to prepare the beverage(s) in the order. In a specific, non-limiting example, the check can allow beverages requiring ingredients M and N can be assigned to the second secondary robot 634B when ingredient M is out (or low) at the first secondary robot 634A.

Further, each of the beverage robots in the network 630 (and/or the remote system 610) can analyze (e.g., via one or more sensors) the ingredients provided from the respective beverage robot and determine the quality of the beverage. In a specific, non-limiting example, the beverage robots in the network 630 can each require an operator to scan (or otherwise enter) identification information (e.g., a QR code, bar code, identification number, and/or the like) for ingredients as they are installed and/or replaced in the beverage robots. The identification information can be used to trace an ingredient to an ingredient lot with measured flavor qualities (e.g., concentration of flavors, pH levels, sweetness levels, and/or the like). The primary robot 632 and/or the secondary robots 634 can then use the measured flavor qualities to adjust a recipe for the beverages in an order (e.g., decrease a volume of an ingredient associated with a relatively concentrated lot; reduce sugar in a recipe with an ingredient associated with relatively high sweetness levels, and/or the like). Additionally, or alternatively, the primary robot 632 and/or the secondary robots 634 can prompt the operator to immediately replace a new ingredient when the identification information is associated with a bad ingredient lot and/or an ingredient lot with flavor profiles outside an acceptable range.

In another specific, non-limiting example, the primary robot 632 and/or the secondary robots 634 can have sensor(s), such as a pH meter, to measure the pH value of an ingredient and determine the acidity or basicity level of the ingredient. The primary robot 632 and/or the secondary robots 634 can compare the determined pH value for the ingredient to a predetermined threshold or range for the ingredient to have the desired flavor for customer satisfaction. If the determined pH value is outside of the predetermined range/threshold for the ingredient, the primary robot 632 and/or the secondary robots 634 can determine an adjustment to the recipes that include the ingredient. For example, if coffee in a container, such as a BIB, is identified as acidic, the beverage robot can adjust levels of other ingredients, such as milk or sugar, in the recipes that include coffee (and/or add ingredients) to lower the acidity level of the coffee and/or otherwise account for the acidic flavor. In some embodiments, if the determined pH value is outside of the predetermined range/threshold for the ingredient, the primary robot 632 and/or the secondary robots 634 can generate and display a notification for the ingredient to be replaced.

In another specific, non-limiting example, the primary robot 632 and/or the secondary robots 634 can include sensor(s), such as a refractometer, to measure the levels of sucrose (sugar) present in an ingredient to determine the sweetness level (or brix value) of the ingredient. The primary robot 632 and/or the secondary robots 634 can then compare the determined sucrose level for the ingredient to a predetermined threshold or range for the ingredient to have the desired flavor for the recipe. If the determined sucrose level is outside of the predetermined range/threshold for the ingredient, the primary robot 632 and/or the secondary robots 634 can determine an adjustment to the recipes that include the ingredient. For example, if a juice in a BIB is identified as too sweet, the beverage robot can adjust levels of other ingredients (e.g., water or a sour liquid) and/or reduce levels of the juice in recipes that include the juice to lower the sweetness of the resulting beverage. In some embodiments, if the determined sucrose level is outside of the predetermined range/threshold for the ingredient, the primary robot 632 and/or the secondary robots 634 can generate and display a notification for the ingredient to be replaced.

By monitoring the flavor profile information of each ingredient, the primary robot 632 and/or the secondary robots 634 can identify changes in the flavor of ingredients before a beverage is created and served to a customer. The primary robot 632, and/or the secondary robots 634 can adjust a recipe for the beverage to account for changes in the quality of the ingredient(s). In turn, the adjustment to the recipe can help improve a consistency in the flavor profile of the beverages produced by the beverage robots. As a result, customers can receive consistent-tasting beverages for an excellent consumption experience.

In some embodiments, the primary robot 632 and/or the secondary robots 634 perform tests to determine if a BIB needs to be replaced and/or maintenance performed on the BIB. For example, each of the beverage robots in the network 630 can measure the weight of a BIB to determine the volume of the ingredient in the BIB. If the weight is below a threshold (e.g., indicating the BIB is empty or nearly empty), the beverage robots can display a notification on a user interface to replace the BIB. In another example, the beverage robots can measure the suction level required to withdraw an ingredient from a BIB. If the suction level is above a threshold (e.g., indicating the BIB is empty or at a low ingredient level), the beverage robots can display a notification on a user interface to replace the BIB. In another example, the beverage robot can determine whether an ingredient in a BIB is expired and needs to be replaced. The beverage robots can start a timer when a BIB is installed to determine when the BIB needs to be replaced. The timer can be based on the type of ingredient in the BIB. When the timer expires, the beverage robots can display a notification on a user interface to replace the BIB and/or prevent the ingredient from being dispensed until replaced. In another example, the beverage robots can monitor the temperature of ingredient in a BIB. If the temperature is above or below an acceptable range for the ingredient for more than a time threshold, the beverage robots can display a notification on a user interface to replace the BIB.

Additionally, or alternatively, the primary robot 632, and/or the secondary robots 634 can make information, about the quality of the ingredients and the status of the BIBs at each of the beverage robots in the network 630, accessible to staff at the vending location 620. The information can increase transparency on the ingredient quality and status of each ingredient. The increase in transparency can help increase customer satisfaction, maintain drink integrity, and/or schedule BIB replacements, and/or the like. The primary robot 632 and/or the secondary robots 634 can display notifications on user interfaces and/or send the information about the quality of the ingredients and the status of the BIBs to onsite computing system 626, the POS system 624, and/or the remote system 610.

Although the processes related to checking ingredient quality and BIB status have been discussed as being executed by the primary robot 632 and/or the secondary robots 634, one of skill in the art will understand that the technology disclosed herein is not so limited. For example, the processes of checking ingredient quality, checking BIB status, and/or adjusting recipes can be executed by the onsite computing systems 626 (which can sometimes be designated as an onsite “virtual primary robot”). Receiving ingredient quality and BIB status information from the onsite computing systems 626 can reduce the computational power required in any of the beverage robots. In another example, the processes of checking ingredient quality, checking BIB status, and/or adjusting recipes can be executed by the remote system 610 (which can sometimes be designated as a cloud-implemented “virtual primary robot”) and relayed to the beverage robots through a network communication system. Further, the beverage robot assigned as the primary robot 632 does not necessarily remain constant. For example, because any of the beverage robots can include a platform generally similar to the subsystem 400 (and the platform 410 therein) discussed above with reference to FIG. 4, any of the beverage robots can be designated as the primary robot. The non-permanent designation can be useful, for example, to allow a beverage robot currently designated as the primary robot to undergo maintenance procedures while one of the beverage robots designated as a secondary robot is promoted to the primary robot designation.

The POS system 624 can receive (e.g., from the remote system 610) the information regarding ingredient quality, recipe adjustments, and or BIB status, and relay the information to the network 630 of beverage robots. The primary robot 632 (and/or the remote system 610 and/or the secondary robots 634) can use the information to dynamically adjust recipe ratios of the beverage(s) (e.g., based on the quality of the ingredients), trigger a notification to display on a user interface to replace a BIB, and/or the like. The primary robot 632 can then provide information to the remote system 610 (and/or the POS system 624) related to the status of ingredients and/or the BIBs. By monitoring the flavor profile information of each ingredient, when a change in ingredient flavor is detected (e.g., due to drift during storage and/or variation between lots), the remote system 610 (and/or the POS system 624) can instruct the network 630 of beverage robots to adjust recipe ratios accordingly to compensate for the flavor change. In a first example, primary robot 632 (and/or the secondary robots 634) detects a new ingredient lot and sends the lot information to the remote system 610 and/or the POS system 624. Upon receiving the lot information, the remote system 610 and/or the POS system 624 can instruct the primary robot 632 (and/or the secondary robots 634) to adjust recipe ratios of a beverage(s) based on the quality information of the detected ingredient. In a second example, the remote system 610 updates all the drink recipe libraries of the beverage robots when a new ingredient lot is added to the remote system 610. Thus, when the primary robot 632 (and/or the secondary robots 634) detects the ingredient lot, the recipe ratio adjustments for the ingredient are made according to the updated recipe library. As a result, customers can receive beverages with a consistent flavor profile and an overall improved drinking experience. Additional details on various processes related to analyzing ingredients, adjusting recipe ratios, receiving, assigning, producing, and/or managing the orders, and associated systems and methods, are discussed below with reference to FIGS. 7-9.

FIG. 7 is a flow diagram of a process 700 for operating a mesh network with a plurality of beverage robots in accordance with some embodiments of the present technology. The mesh network can be generally similar to the mesh network 600 discussed above with reference to FIG. 6. Further, it will be understood that the process 700 can be executed by any suitable computing devices in the mesh network. For example, the process 700 can be executed by a computing device housing the platform 300 discussed above with reference to FIG. 3; the subsystem 400 discussed above with reference to FIG. 4; the remote system 610, the POS system 624, the onsite computing system 626, and/or the primary robot 632 discussed above with reference to FIG. 6; and/or the like. Additionally, or alternatively, although discussed herein in the context of being executed entirely within a single component (e.g., entirely within the primary robot 632 and/or the remote system 610 of FIG. 6), it will be understood that one or more steps in the process 700 can be executed by a different computing device than one or more other steps.

In some embodiments, process 700 can be triggered by a detection that an ingredient container (e.g., a BIB) needs to be replaced (e.g., based on low ingredient levels, expired ingredients, incorrect ingredient installed, drift in flavor (e.g., increase in acidity) over time, and/or the like). The detection can be made by a beverage robot, such as any of the beverage robots in the network 630 discussed above with reference to FIG. 6. The beverage robot can then display an indication regarding the replacement (e.g., a low ingredient level, a dispense incomplete error notification, an expired ingredient notice, and/or the like) to signal that an ingredient needs to be replenished (e.g., by replacing a BIB). An operator (e.g., a staff member at the vending location of the beverage robot) can retrieve a new BIB (or other suitable ingredient container) from the inventory and present the new BIB to the intended beverage robot to replace the ingredient. When the operator replaces the BIB, the beverage robot (or any other suitable component) can execute the process 700 to confirm the correct ingredient is installed, confirm the ingredient is usable (e.g., not expired, not spoiled, not beyond a shelf life, and/or the like), check various flavor qualities of the new ingredient, and adjust beverage recipes to account for the flavor qualities of the ingredient.

As illustrated in FIG. 7, the process 700 can begin at block 702 by detecting the new BIB presented to the beverage robot. The detection at block 702 can include identifying information about the new BIB. For example, the beverage robot (and/or the operator) can scan an identifier (e.g., barcode, QR code, and/or the like) on the BIB to identify the ingredient within the BIB and ingredient information. In another example, the beverage robot can receive inputs (e.g., a BIB ID number) from the operation that provide the identifying information.

At block 704, the process 700 includes retrieving ingredient quality information about the ingredient in the new BIB from a peripheral database (e.g., from the remote system 210 of FIG. 2, from the remote system 610 of FIG. 6, a third-party database and/or the like). The ingredient quality information can include the type of ingredient, the expiration date, lot information (e.g., batch numbers) acidity or basicity levels, sweetness level, brix value, nutrient table, concentration levels, manufacturer information, and/or the like. The ingredient quality information retrieved at block 704 can be based on one or more measurements performed when packaging batches of the ingredient (e.g., acidity, sweetness, and/or concentration levels of a batch of ingredients that are packaged and tracked to the batch). The batch-level measurements can provide cost-effective measurements that process 700 can use to account for variances between batches. The beverage robot can display the ingredient information on a user interface, allowing an operator to confirm the new BIB conforms with their expectations. In some embodiments, process 700 at block 704 includes registering information on the BIB with the beverage robot system (e.g., remote system 210 of FIG. 2) to keep a record of when BIBs are consumed. The record can include an identification of the new BIB, a tube number (e.g., vending lines 560 of FIG. 5) the new BIB is installed with, a location within the beverage robot, and/or the like.

At block 706, the process 700 includes performing an analysis of the ingredient information to identify a variety of errors. For example, the beverage robot can determine if the new BIB is correctly installed at the beverage robot, if the ingredient in the new BIB is expired, if the ingredient in the new BIB is past its shelf life, if the correct new BIB was installed, a temperature of the new BIB, and/or the like. In a specific, non-limiting example, the new BIB can be a new milk package. In this example, the process 700 can include confirming that the milk is not past an expiration date for the new BIB, checking a temperature of the new BIB to confirm the milk was stored as appropriate before being installed, confirming the milk is not beyond a shelf life based on the storage conditions, and confirming that the new BIB is correctly installed (e.g., valves fully connected, placed in a refrigerator in the beverage robot, and/or the like). In some embodiments, the analysis at block 706 can check various qualities of the ingredient using one or more sensors in the beverage robot. For example, the beverage robot can measure acidity or basicity levels, sweetness levels, brix value, concentration levels, and/or the like. The analysis at block 706 can provide a second data point to confirm and/or supplement the ingredient information retrieved at block 704. Purely by way of example, the second data point can help check for drift in various qualities of the ingredient (e.g., pH levels) during storage.

At decision block 708, if no errors were identified for the ingredient of the scanned BIB the process 700 continues to block 712. If one or more errors were identified, the process 700 continues to block 710.

At block 710, the process 700 includes adjusting and/or replacing the new BIB. The beverage robot can display an error message and/or instructions on the user interface to replace the new BIB. For example, if an incorrect new BIB is scanned (e.g., replacing ingredient A but the new BIB is ingredient B), the beverage robot can display an error message. In another example, if the new BIB is expired, the beverage robot can display an expiration message. In yet another example, when the new BIB is incorrectly installed (e.g., valves not fully connected, BIB placed in incorrect compartment, and/or the like), the beverage robot can display an error message and instructions to correct the error. By displaying error messages and/or instructions, the beverage robot can guide an operator at the vending location through the refill process to help ensure seamless and accurate replenishment of the ingredient.

At block 712, the process 700 includes determining whether the qualities of the ingredient in the new BIB necessitate adjustments to the recipes for one or more beverages that the beverage robot can prepare. For example, the process 700 can check whether the sweetness of the ingredient (e.g., a juice concentrate) is within a predetermined acceptable range. If the sweetness is outside of the acceptable range, the beverage robot can determine that an adjustment to the recipes will be required to maintain consistency in the flavor profile of resulting beverages. The beverage robot can perform similar checks based on the acidity (or basicity), concentration, temperature, and/or any other suitable information related to the ingredient in the new BIB. Additionally, or alternatively, the process 700 includes the beverage robot retrieving, from a remote system (e.g., the remote system 610 of FIG. 6), any recipe adjustments associated with the ingredient of a new BIB and applying the recipe adjustments to received orders.

At decision block 714, if no adjustment is needed for the ingredient the process 700 continues to block 716. If an adjustment is needed for the ingredient, the process 700 continues to block 718.

At block 716, the process 700 includes preparing the beverage robot for operation. For example, the beverage robot can display a message indicating the BIB installation is complete. Additionally, or alternatively, the operator can select a button(s) on the user interface of the beverage robot to resume normal operation, such as filling tubs and waiting to receive an order.

At block 718, the process 700 includes determining adjustments to each of the recipes that include the ingredient in the new BIB. The adjustments at block 718 compensate for variances in the ingredient qualities (e.g., sweetness levels, pH levels, nutrient table, brix value, concentrations, and/or the like) to improve a consistency in the taste of beverages prepared with different batches of the ingredients. That is, the adjustments to recipe ratios can help improve a consistency in the flavor profile of the beverages that include the identified ingredient. As a result, customers receive consistently tasting beverages for an improved consumption experience. In one example, if the ingredient in the BIB has an acidity level above a threshold, the process 700 can adjust the ratio of other ingredients (e.g., milk or sugar) in the recipe to lower the acidity level of the resulting beverage to compensate for the ingredient. Additionally, or alternatively, the process 700 can add (or remove) one or more ingredients (e.g., sugar) to compensate for the ingredient. In another example, if the ingredient in the BIB has a brix value above a threshold, the process 700 can adjust the ratio of other ingredients (e.g., water, simple syrup and/or sugar, and/or a sour liquid) in the recipe and/or add (or remove) ingredients to lower the sweetness of the resulting beverage to compensate for the ingredient. In yet another example, if the ingredient in the BIB has an acidity level or a sweetness level below threshold, the process 700 can adjust the ratio of other ingredients in the recipe and/or add (or remove) ingredients to increase the acidity level or sweetness level of the resulting beverage. In yet another example, when the concentration level of the ingredient is outside of a predetermined range (e.g., less or more concentrated than a baseline range), the process 700 can adjust a ratio of the ingredient (e.g., increase or decrease the amount of the ingredient) in the recipe to compensate for the concentration level.

At block 720, the process 700 includes communicating the quality information of the ingredient and/or the adjustments to the recipes to other beverage robots at the vending location and/or other components of the system (e.g., remote system 610 of FIG. 6). By communicating the ingredient quality information and/or the adjustments to the recipes, the other beverage robots and/or the system can identify changes in the flavor of ingredients before a beverage is created. Additionally, the other beverage robots (and/or other components of the system) can be apprised of the different ingredients the beverage robot needs to prepare the beverages that include the new ingredient (e.g., allowing the primary robot 632 and/or the remote system 610 to better track which of the secondary robots 634 can prepare a beverage based on the available ingredients). Additionally, or alternatively, the process 700 includes the remote system (e.g., the remote system 610 of FIG. 6) communicating the quality information of the ingredient and/or the adjustments to the recipes to the beverage robots of the system.

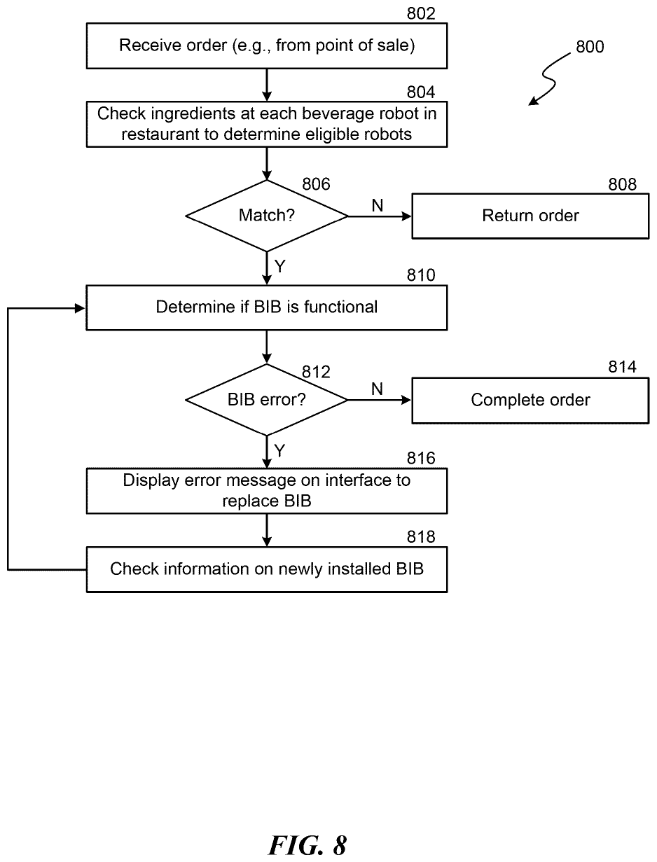

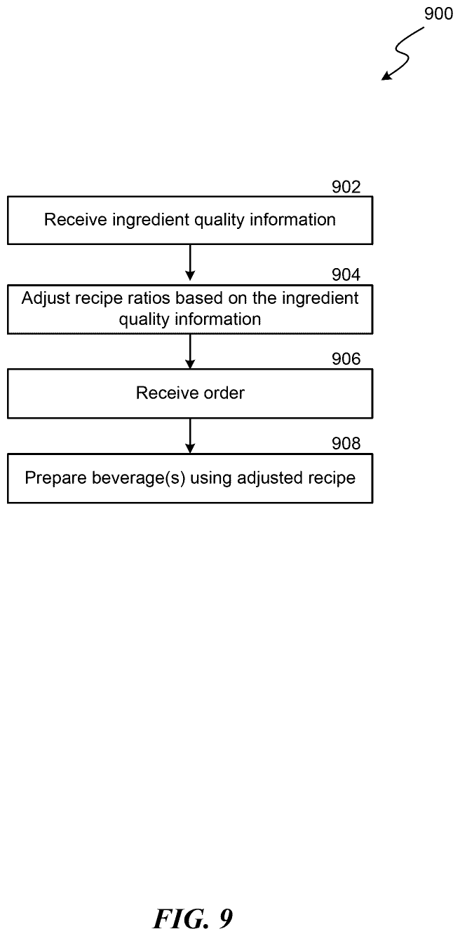

Although the blocks 702-720 of the process 700 are discussed and illustrated in a particular order, the process 700 illustrated in FIG. 7 is not so limited. For example, various steps of the process 700 can be performed in a different order. In these and other embodiments, any of the blocks 702-720 of the process 700 can be performed before, during, and/or after any of the other blocks 702-720 of the process 700. In a specific, non-limiting example, all or a subset of the blocks 712-720 can be executed before executing block 708 to decide whether the BIB has an error. The switch can be useful, for example, when the BIB has already been successfully installed in the beverage robot, during quality checks, or when performing routine maintenance on the beverage robot. Moreover, a person of ordinary skill in the relevant art will recognize that the illustrated process 700 can be altered and still remain within these and other embodiments of the present technology. For example, the process 700 can be modified in view of any of the processes discussed below with reference to FIGS. 8-9.

FIG. 8 is a flow diagram of a process 800 for determining robot functionality within a mesh network with a plurality of beverage robots in accordance with some embodiments of the present technology. The mesh network can be generally similar to the mesh network 600 discussed above with reference to FIG. 6. Further, it will be understood that the process 800 can be executed by any suitable computing devices in the mesh network. For example, the process 800 can be executed by a computing device housing the platform 300 discussed above with reference to FIG. 3; the subsystem 400 discussed above with reference to FIG. 4; the remote system 610, POS system 624, the onsite computing system 626, and/or the primary robot 632 discussed above with reference to FIG. 6; and/or the like. Additionally, or alternatively, although discussed herein in the context of being executed entirely within a single component (e.g., entirely within the primary robot 632 and/or the remote system 610 of FIG. 6), it will be understood that one or more steps in the process 800 can be executed by a different computing device than one or more other steps.

As illustrated in FIG. 8, the process 800 can begin at block 802 by receiving an order. The order can be received from a POS system (e.g., a register, electronic kiosk, electronic terminal, and/or the like), a remote system (e.g., a cloud system coupled to an app for a mobile device, a web-based POS, and/or the like), and/or any other suitable system. The order can include one or more beverages to be prepared by beverage robots in the mesh network. Each of the beverages is associated with a recipe that requires one or more ingredients (e.g., concentrated juices, syrups, coffee, tea, and/or the like; water; sparkling and/or carbonated water; milk and/or milk alternatives; and/or the like). Further, the recipe for each of the beverages can vary between each beverage robot in the network based on the ingredients available at each of the beverage robots. In a specific, non-limiting example, ingredient A₁ installed in a first beverage robot can have a first sweetness level while ingredient A₂ installed in a second beverage robot has a second sweetness level that is less than the first sweetness level (e.g., based on differences between lots for ingredient A). Accordingly, a recipe for a beverage including ingredient A₂ at the second beverage robot can include additional simple syrup (or sugar) as compared to the recipe at the first beverage robot to help improve consistency in the sweetness of the resulting beverages when prepared by the first and second beverage robots.

At block 804, the process 800 includes checking the ingredients available at each beverage robot in the mesh network to determine a list of eligible robot(s) available to help produce the order. To be available to help produce the order, a beverage robot must have the ingredients required for one or more of the beverage(s) in the order according to a recipe specific to the relevant beverage robot. Accordingly, checking the ingredients available at each beverage robot in the mesh network to determine the list of eligible robots can include identifying the ingredients required for each beverage in the order (e.g., based on adjusted recipe ratios, the recipe for each beverage, and/or any modifications in the order). Identifying the required ingredients can include retrieving a list of each of the recipes from a central database (e.g., a storage device in the primary robot, at the remote system, and/or the like), another database (e.g., querying an onsite computing system) for the recipes, and/or one or more of the beverage robots in the mesh network. Similarly, checking the ingredients available at each of the beverage robot(s) can include retrieving a list of ingredients available (e.g., in stock, stored, etc.) at each beverage robot in a central database, querying another database for the list, and/or querying each of the beverage robots in the mesh network. The process 800 at block 804 can then review the ingredients available at each of the beverage robots to identify eligible robots that are available to prepare at least one beverage (or all beverages) in the order based on a corresponding recipe specific to the beverage robots (e.g., including any adjustments). For example, if an ingredient at a chosen beverage robot has a change in sweetness or acidity level, the chosen beverage robot needs to have the necessary ingredients to alter the sweetness or acidity level for the beverage.

At decision block 806, if no matches were identified for one or more items in the order (e.g., no eligible robots available to prepare the item(s)) the process 800 continues to block 808. If one or more matches were identified, the process 800 continues to block 810.

At block 808, the process 800 returns the order to a POS system, a remote system, and/or any other suitable destination. The return can identify that none of the beverage robots are available to help produce the order. For example, when an order is for food items, canned/bottled beverages, and/or the like, the beverage robots will not be available to help produce any portion of the order. In this example, the return confirms (e.g., to the POS system and/or another suitable endpoint) that the beverage robots will not take any action. Additionally, or alternatively, the return can indicate an error with the order. The error can prompt an operator to take a corrective action (e.g., replace an empty BIB in one or more beverage robots so they become available to produce the order). Additionally, or alternatively, the error can prompt the POS system (or other suitable component) to make one or more changes to the order and/or refund the customer for a portion of the order. For example, the error can indicate that one or more ingredients are fully out of stock at the vending location and the return can prompt the POS system to request a change to the order and/or refund the portion of the order requiring the out-of-stock ingredients.

At block 810, the process 800 includes determining if the BIB(s) holding the ingredient is functional to complete the order. More specifically, the process 800 can perform tests (e.g., in conjunction with the eligible robot(s)) to determine if the BIB(s) needs to be replaced and/or maintenance performed on the BIB. For example, the eligible robot(s) measures the weight of the BIB to determine the volume of the ingredient in the BIB. If the weight of the BIB is below a threshold, the eligible robot(s) can determine that there is not enough of the ingredient to complete the order. In another example, the eligible robot(s) measures the suction power required to withdraw the ingredient from the BIB. If the suction power is above a threshold, the eligible robot(s) can determine that there is either an error with the suction system or there is not enough of the ingredient to complete the order. In yet another example, the eligible robot(s) determines whether the ingredient in the BIB is expired. If the ingredient is expired, the eligible robot(s) is unable to complete the order. In yet another example, the eligible robot(s) monitors the temperature of the ingredient in the BIB. If the temperature is outside of a range for a predetermined amount of time, the eligible robot(s) can determine that the ingredient is spoiled and should not be used to complete the order.

At decision block 812, if no errors were identified for one or more items in the order (e.g., the necessary BIBs are functional) the process 800 continues to block 814. If one or more errors were identified, the process 800 continues to block 816.

At block 814, the process 800 completes the order. Completing the order can include determining one or more chosen robots from the eligible robots to produce the order (or prepare any suitable subset of the beverages in the order). The determination of the chosen robot(s) can be based on which of the eligible robots can prepare one or more of the beverage(s) in the order fastest. For example, the determination can identify the eligible robots with the shortest queue(s) and assign them one or more of the beverages from the order. The chosen robot(s) can receive the assignment of the order (or any suitable subset of the beverages in the order). As a result, the chosen robot(s) can add the beverages in the assignment to the corresponding queue and prepare the assigned beverages after preparing any beverages that were already in the queue. The assignment can include sending (e.g., transmitting) the order (or any suitable subset of the order) to the chosen robot(s). Additionally, the assignment can include sending an indication of the assignment to any other suitable destination. For example, the assignment can include updating the database in the primary robot to update the queue corresponding to the chosen robot(s). In another example, the assignment can include sending the assignment to the POS system, the onsite computing devices, and/or the remote system to update queues stored therein, update a status of the order visible to a customer associated with the order, and/or the like. In some embodiments, the assignment places the order (or any suitable subset of the order) at the back of the queue at the chosen robot(s). In some embodiments, the assignment places the order higher on the queue at the chosen robot(s) (e.g., to expedite an order with a high priority). In some embodiments, completing the order includes adjusting a recipe(s) for the beverages to account for variances in the quality of the ingredients.

Completing the order can include prompting vending location personnel to deliver the order to the customer (or other suitable person), cleansing one or more components of the chosen beverage robot(s), and/or resetting the chosen beverage robot(s) for the next order. Additionally, or alternatively, completing the order can include updating the queue(s) at the chosen robot(s) to remove the beverage(s) assigned to them and/or updating the record to reflect the completed orders. Records of the completed orders can be stored on a database at the primary robot, the POS system, the onsite computing devices, and/or the remote system for future reference (e.g., to review sales trends, common modifications to recipes, popular drinks, periods of high demand, transaction history, mileage for the beverage robots, and/or the like).

At block 816, the process 800 includes displaying an error message on the user interface of the beverage robot. The error can indicate that one or more ingredients need to be replaced in the beverage robot (e.g., by replacing one or more BIB systems) before the order can be produced. For example, if the weight of the BIB is below a threshold (e.g., indicating the BIB is empty or nearly empty), the beverage robot displays a notification on the user interface to replace the BIB. In another example, if the suction power to withdraw the ingredient from the BIB is above a threshold (e.g., indicating the BIB is empty or at a low ingredient level), the beverage robot displays a notification on the user interface to replace the BIB. In yet another example, if the ingredient in the BIB is expired, the beverage robot displays a notification on the user interface to replace the BIB. In yet another example, if the temperature of the ingredient is outside the acceptable range for the ingredient for more than the predetermined amount of time, the beverage robot displays a notification on the user interface to replace the BIB.

At block 818, the process 800 includes checking information on the newly installed BIB. The process 800 at block 818 can be generally similar to the process 700 discussed above with reference to FIG. 7 to identify and account for variances in an ingredient across BIBs, confirm that the new BIB is the correct ingredient, confirm the new BIB is not expired, and/or the like. After the BIB is replaced, process 800 can repeat any of blocks 810-816 for the new BIB.

Although the blocks 802-816 of the process 800 are discussed and illustrated in a particular order, the process 800 illustrated in FIG. 8 is not so limited. For example, various steps of the process 800 can be performed in a different order. In these and other embodiments, any of the blocks 802-816 of the process 800 can be performed before, during, and/or after any of the other blocks 802-816 of the process 800. In a specific, non-limiting example, all or a subset of the blocks 810-816 can be executed before executing block 802 to receive an order. The switch can be useful, for example, to determine that the BIBs of the beverage robot are functional prior to receiving orders. Moreover, a person of ordinary skill in the relevant art will recognize that the illustrated process 800 can be altered and still remain within these and other embodiments of the present technology. For example, the process 800 can be modified in view of any of the processes discussed below with reference to FIGS. 7 and 9.

FIG. 9 is a flow diagram of a process 900 for adjusting recipe ratios of orders in production at a plurality of beverage robots in accordance with some embodiments of the present technology. More specifically, the process 900 illustrated in FIG. 9 can be executed to help maintain consistent flavor profiles for beverages when the ingredient quality changes. Similar to the processes discussed above with reference to FIGS. 7-8, the process 900 can be executed by any suitable computing device (or combination of computing devices) in a mesh network of the type discussed above. Purely by way of example, the process 900 (or any suitable portion thereof) can be executed by a computing device housing the platform 300 discussed above with reference to FIG. 3; the subsystem 400 discussed above with reference to FIG. 4; and/or any of the components of the mesh network 600 discussed above with reference to FIG. 6. Further, it will be understood that the process 900 (and/or a generally similar process) can be executed as a part of and/or after the processes discussed above. Purely by way of example, the primary robot 632 and/or the remote system 610 of FIG. 6 can execute the process 900.

The process 900 begins at block 902 by receiving ingredient quality information for a varied ingredient (e.g., a new ingredient BIB installed in a beverage robot, an ingredient with drift in flavor qualities, and/or the like). A beverage robot and/or a POS system can receive the ingredient quality information from a remote system. In some embodiments, the POS system receives the ingredient quality information and relays the information to the beverage robot(s) at the vending location. The ingredient quality information can include acidity or basicity levels, sweetness levels, concentration levels, filtration level (e.g., mesh size), % purity, content breakdown (e.g. total dissolved solids, ratio of caffeine or other compounds), aroma levels, brix value (e.g., concentration of sugar/sucrose), nutrient table, fact content, and/or the like. Process 900 can include identifying changes in the ingredient quality that will affect the flavor of the ingredient and any that include the ingredient.

At block 904, the process 900 includes adjusting the recipe of each of the beverages that use the varied ingredient to account for the changes in ingredient quality. In a specific, non-limiting example, the recipe for a beverage can include 2 ounces of a first ingredient, 3 ounces of a second ingredient, and 5 ounces of third ingredient. Due to the acidity level of the first ingredient, the process 900 can adjust the recipe to 2 ounces of a first ingredient, 3 ounces of a second ingredient, 6 ounces of the third ingredient. Additionally, or alternatively, the process 900 can increase a volume of the second ingredient added to the beverage. In another example, the process 900 can modify an order by adding one or more ingredients to a recipe of the beverage to account for the changes in the ingredient quality. Returning to the specific, non-limiting example above, the process 900 can add a half an ounce of a fourth ingredient to the recipe to help counteract the acidity of the first ingredient. Further, the process 900 at block 904 can include sending an indication of the adjusted recipe (sometimes also referred to herein as “updated recipes,” “modified recipes,” and/or the like) to any other suitable destination. For example, the process 900 at block 908 can include updating the central database to update the recipe for the beverage and the queue corresponding to the chosen robot. In another example, the process 900 at block 908 can include sending the updated recipe to the POS system, the onsite computing devices, and/or the remote system to update recipes stored therein, and/or the like.

At block 906, the process 900 includes receiving an order. The order can be received from a POS system (e.g., a register, electronic kiosk, electronic terminal, and/or the like), a remote system (e.g., a cloud system coupled to an app for a mobile device, a web-based POS, and/or the like), and/or any other suitable system. The order can include one or more beverages to be prepared by beverage robots in the mesh network. One or more of the beverage(s) can be associated with an adjusted recipe that requires the varied ingredient (e.g., concentrated juices, syrups, coffee, tea, and/or the like; water; sparkling and/or carbonated water; milk and/or milk alternatives; and/or the like).

At block 908, the process 900 includes preparing the beverage(s) in the order that include the varied ingredient according to the adjusted recipes and preparing any other beverages in the order according to their original recipes. The process 900 at block 908 can include sending (e.g., transmitting) the adjusted recipes and preparation instructions to beverage robots chosen to prepare the beverage(s). As a result, the chosen robots will add the beverage(s) to their queue (or modify their queue) and prepare the beverage(s) according to the adjusted recipes.

Although the blocks 902-904 of the process 900 are discussed and illustrated in a particular order, the process 900 illustrated in FIG. 9 is not so limited. For example, various steps of the process 900 can be performed in a different order. In these and other embodiments, any of the blocks 902-908 of the process 900 can be performed before, during, and/or after any of the other blocks 902-908 of the process 900. In a specific, non-limiting example, the process 900 can omit block 902 and/or block 904 based on information received while executing any of the other processes disclosed herein. Moreover, a person of ordinary skill in the relevant art will recognize that the illustrated process 900 can be altered and still remain within these and other embodiments of the present technology. For example, the process 900 can be integrated into any of the processes discussed above with reference to FIGS. 7-8.

### EXAMPLES

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.
1. A method for operating a network having one or more beverage robots, the method comprising:
detecting a new ingredient container installed into a beverage robot from the one or more beverage robots;
retrieving ingredient quality information related to an ingredient in the new ingredient container, wherein the ingredient quality information includes one or more of a an acidity level, a brix value, a nutrient table, content, and/or a concentration level for the ingredient in the new ingredient container;
for each individual recipe including the ingredient in the new ingredient container,
   determining whether adjustments to the individual recipe are needed based on the ingredient quality information;
   in response to a determination that adjustments are needed, adjusting the individual recipe to create a modified individual recipe based on the ingredient quality information; and
   storing the modified individual recipe for use in preparing beverages that include the ingredient at the beverage robot.
2. The method of example 1, wherein:
retrieving ingredient quality information related to an ingredient in the new ingredient container comprises: in response to the beverage robot scanning an identifier of the new ingredient container, retrieving, from a database, the concentration level of the ingredient in the new ingredient container; and
for each of the individual recipes including the ingredient in the new ingredient container,
   determining whether adjustments to the individual recipe are needed comprises determining if the concentration level of the ingredient is outside of a predetermined range; and
   adjusting the individual recipe to create the modified individual recipe comprises making one or more adjustments to the individual recipe to counteract the concentration level.
3. The method of any of examples 1-2, wherein:
retrieving ingredient quality information related to an ingredient in the new ingredient container comprises: in response to the beverage robot scanning an identifier of the new ingredient container, retrieving, from a database, the brix value of the ingredient in the new ingredient container; and
for each of the individual recipes including the ingredient in the new ingredient container,
determining whether adjustments to the individual recipe are needed comprises determining if the brix value of the ingredient is outside of a predetermined range; and
adjusting the individual recipe to create the modified individual recipe comprises making one or more adjustments to the individual recipe based on the brix value.
4. The method of any of examples 1-3, wherein the ingredient quality information is a first set of ingredient quality information and the modified recipe is a first modified recipe, and wherein the method further comprises:
receiving a second set of ingredient quality information of the ingredient in the new ingredient container;
determining the first set of ingredient quality information does not match the second set of ingredient quality information; and
in response to the first set of ingredient quality information not matching the second set of ingredient quality information, generating a second modified individual recipe based on the second set of ingredient quality information.
5. The method of any of examples 1-4, further comprising:
receiving an order requesting a beverage from the network;
in response to receiving the order, retrieving the modified individual recipe associated with the beverage to determine required ingredients for the beverage; and
checking a list of stored ingredients to determine if the beverage robot has the required ingredients to make the beverage according to the adjusted individual recipe.
6. The method of any of examples 1-5, further comprising:
receiving an order requesting a beverage from the network associated with an individual modified recipe;
assigning the beverage to the beverage robot from the one or more beverage robots, wherein assigning the beverage to the beverage robot causes the order to be added to a robotic queue at the beverage robot, and wherein the robotic queue is associated with beverages to be prepared by the beverage robot; and
preparing the beverage according to the individual modified recipe.
7. The method of any of examples 1-6, wherein the ingredient quality information further comprises an expiration date for the ingredient in the new ingredient container, and wherein the method further comprises:
determining the ingredient is expired based on the ingredient quality information; and
displaying, to an operator of the one or more beverage robots via a user interface on the beverage robot, a notification that the ingredient is expired.
8. A system comprising:
one or more processors; and
one or more memories storing instructions that, when executed by the one or more processors, cause the system to perform a process for operating a network having one or more beverage robots, the process comprising:
   determining ingredient quality information related to an ingredient, wherein the ingredient quality information includes one or more of a an acidity level, a brix value, a nutrient table, content, and/or a concentration level for the ingredient in a beverage container;
   for each individual recipe including the ingredient in the beverage container,
      determining whether adjustments to the individual recipe are needed based on the ingredient quality information;
      in response to a determination that adjustments are needed, adjusting the individual recipe to create an adjusted individual recipe based on the ingredient quality information; and
      sending, to the one or more beverage robots, the adjusted individual recipe for use in preparing beverages that include the ingredient.
9. The system of example 8, wherein the process further comprises:
determining the concentration level of the ingredient is outside of a predetermined range; and
in response to the concentration level being outside of the predetermined range, adjusting the individual recipe to create the adjusted individual recipe based on the concentration level.
10. The system of any of examples 8-9, wherein the process further comprises:
determining the brix value of the ingredient has reached a brix threshold; and
in response to the brix value reaching the brix threshold, adjusting the individual recipe to create the adjusted individual recipe based on the brix value.
11. The system of any of examples 8-10, wherein the ingredient quality information is first ingredient quality information, wherein the process further comprises:
retrieving, from a database, second ingredient quality information of the ingredient;
determining whether the first ingredient quality information matches the second ingredient quality information;
in response to the first ingredient quality information not matching the second ingredient quality information, generating a second adjusted individual recipe based on the second ingredient quality information; and
sending, to the one or more beverage robots, the second adjusted individual recipe for use in preparing beverages that include the ingredient.
12. The system of any of examples 8-11, wherein the process further comprises:
receiving an order requesting a beverage;
in response to receiving the order, retrieving the adjusted individual recipe associated with the beverage to determine required ingredients for the beverage; and
checking a list of stored ingredients to determine if the one or more beverage robots have the required ingredients to make the beverage according to the adjusted individual recipe.
13. The system of any of examples 8-12, wherein the process further comprises:
receiving an order requesting a beverage; and
assigning the beverage to a beverage robot from the one or more beverage robots, wherein assigning the beverage to the beverage robot causes the order to be added to a robotic queue at the beverage robot, and wherein the robotic queue is associated with beverages to be prepared by the beverage robot.
14. The system of any of examples 8-13, wherein the ingredient quality information further comprises an expiration date for the ingredient in the ingredient container, and wherein the process further comprises:
determining the ingredient is expired based on the ingredient quality information; and
sending, to the one or more beverage robots, a notification that the ingredient is expired.
15. A non-transitory computer-readable medium storing instructions that, when executed by a computing system, cause the computing system to perform operations for operating a network having one or more beverage robots, the operations comprising:
detecting a new ingredient container installed into a beverage robot from the one or more beverage robots;
retrieving ingredient quality information related to an ingredient in the new ingredient container, wherein the ingredient quality information includes one or more of a an acidity level, a brix value, a nutrient table, content, and/or a concentration level for the ingredient in the new ingredient container;
for each individual recipe including the ingredient in the new ingredient container,
   determining whether adjustments to the individual recipe are needed based on the ingredient quality information;
   in response to a determination that adjustments are needed, adjusting the individual recipe to create a modified individual recipe based on the ingredient quality information; and
   storing the modified individual recipe for use in preparing beverages that include the ingredient at the beverage robot.
16. The non-transitory computer-readable medium of example 15, wherein the operations further comprise:
retrieving, from a database, the concentration level of the ingredient in the new ingredient container;
determining the concentration level of the ingredient is outside of a predetermined range; and
in response to the concentration level being outside of the predetermined range, adjusting the individual recipe to create the adjusted individual recipe based on the concentration level.
17. The non-transitory computer-readable medium of any of examples 15-16, wherein the operations further comprise:
retrieving, from at least one database, the brix value of the ingredient in the new ingredient container;
determining the brix value of the ingredient has reached a brix threshold; and
in response to the brix value reaching the brix threshold, adjusting the individual recipe to create the adjusted individual recipe based on the brix value.
18. The non-transitory computer-readable medium of any of examples 15-17, wherein the ingredient quality information is first ingredient quality information, wherein the operations further comprise:
receiving second ingredient quality information of the ingredient in the new ingredient container;
determining the first ingredient quality information does not match the second ingredient quality information; and
in response to the first ingredient quality information not matching the second ingredient quality information, generate a second adjusted individual recipe based on the second ingredient quality information.
19. The non-transitory computer-readable medium of any of examples 15-18, wherein the operations further comprise:
receiving an order requesting a beverage from the network;
in response to receiving the order, retrieving the adjusted individual recipe associated with the beverage to determine required ingredients for the beverage; and
checking a list of stored ingredients to determine if the beverage robot has the required ingredients to make the beverage according to the adjusted individual recipe.
20. The non-transitory computer-readable medium of any of examples 15-19, wherein the operations further comprise:
receiving an order requesting a beverage from the network;
assigning the beverage to the beverage robot from the one or more beverage robots, wherein assigning the beverage to the beverage robot causes the order to be added to a robotic queue at the beverage robot, and wherein the robotic queue is associated with beverages to be prepared by the beverage robot; and
preparing the beverage according to the adjusted individual recipe.
21. A method for operating a network having one or more beverage robots, the method comprising:
receiving an order requesting the beverage from the network;
assigning the beverage to a chosen beverage robot from the one or more beverage robots, wherein assigning the beverage to the chosen beverage robot causes the chosen beverage robot to add the beverage to a queue at the chosen beverage robot, and wherein the queue is associated with beverages to be prepared by the chosen beverage robot; and
determining if a beverage container installed into the chosen beverage robot is functional, wherein functionality of the beverage container is based on a weight of the beverage container being below a threshold or a suction power required to withdraw an ingredient out of the beverage container being above a threshold; and
in response to determining the beverage container is not functional, displaying a notification on a user interface that the beverage container holding the ingredient needs to be replaced.
22. A method for operating a network having one or more beverage robots, the method comprising:
receiving ingredient quality information related to an ingredient in a beverage container, wherein the ingredient quality information includes one or more of a sweetness level, an acidity level, and/or a concentration level for the ingredient in the beverage container;
for each individual recipe including the ingredient in the container,
   determining whether adjustments to the individual recipe are needed based on the ingredient quality information;
   in response to a determination that adjustments are needed, adjusting the individual recipe to create an adjusted individual recipe based on the ingredient quality information; and
storing the adjusted individual recipe for use in preparing beverages that include the ingredient at the first beverage robot;
receiving an order requesting a beverage from the network;
assigning the beverage to the first beverage robot from the one or more beverage robots, wherein assigning the beverage to the first beverage robot causes the first beverage robot to add the beverage to a queue at the first beverage robot, and wherein the queue is associated with beverages to be prepared by the first beverage robot; and
preparing the beverage according to the adjusted individual recipe.
23. A system comprising:
one or more processors; and
one or more memories storing instructions that, when executed by the one or more processors, cause the system to perform a process for operating a network having one or more beverage robots, the process comprising:
   detecting a new beverage container installed into a first beverage robot from the one or more beverage robots;
   performing a test to an ingredient in the new beverage container;
   determining ingredient quality information related to the ingredient based on the test, wherein the ingredient quality information includes one or more of a sweetness level, an acidity level, and/or a concentration level for the ingredient in the new beverage container;
   for each individual recipe including the ingredient in the new beverage container,
      determining whether adjustments to the individual recipe are needed based on the ingredient quality information;
      in response to a determination that adjustments are needed, adjusting the individual recipe to create an adjusted individual recipe based on the ingredient quality information; and
      storing the adjusted individual recipe for use in preparing beverages that include the ingredient at the first beverage robot.
24. The system of example 23, wherein the process further comprises:
determining the acidity level of the ingredient has reached an acidity threshold based on the test; and
in response to the acidity level reaching the acidity threshold, adjusting the individual recipe to create the adjusted individual recipe based on the acidity level.
25. The system of any of examples 23-24, wherein the process further comprises:
determining the sweetness level of the ingredient has reached a sweetness threshold based on the test; and
in response to the sweetness level reaching the sweetness threshold, adjusting the individual recipe to create the adjusted individual recipe based on the sweetness level.
26. The system of examples 23-25, wherein the ingredient quality information is first ingredient quality information, wherein the process further comprises:
retrieving, from a database, second ingredient quality information of the ingredient in the new beverage container;
determining whether the first ingredient quality information matches the second ingredient quality information; and
in response to the first ingredient quality information not matching the second ingredient quality information, generating a second adjusted individual recipe based on the second ingredient quality information.
27. The system of examples 23-26, wherein the process further comprises:
receiving an order requesting a beverage from the network;
in response to receiving the order, retrieving the adjusted individual recipe associated with the beverage to determine required ingredients for the beverage; and
checking a list of stored ingredients to determine if the first beverage robot has the required ingredients to make the beverage according to the adjusted individual recipe.
28. The system of examples 23-27, wherein the process further comprises:
receiving an order requesting a beverage from the network;
assigning the beverage to the first beverage robot from the one or more beverage robots, wherein assigning the beverage to the first beverage robot causes the first beverage robot to add the beverage to a queue at the first beverage robot, and wherein the queue is associated with beverages to be prepared by the first beverage robot; and
preparing the beverage according to the adjusted individual recipe.
29. The system of examples 23-28, wherein the process further comprises:
scanning an identifier of a container holding that least one ingredient;
determining the ingredient is expired based on information associated with the identifier; and
displaying a notification on a user interface that the ingredient is expired.

### Conclusion

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. In addition, the singular forms “a,” “an,” and “the” herein are intended to comprise the plural forms as well, unless the context clearly indicates otherwise. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Still further, the terms “approximately,” “generally,” and “about” are used herein to mean within at least within 10% of a given value or limit. Purely by way of example, an approximate ratio means within 10% of the given ratio.

Several embodiments of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A method for operating a network having one or more beverage robots, the method comprising:
detecting a new ingredient container installed into a beverage robot from the one or more beverage robots;
retrieving ingredient quality information related to an ingredient in the new ingredient container, wherein the ingredient quality information includes one or more of a an acidity level, a brix value, a nutrient table, content, and/or a concentration level for the ingredient in the new ingredient container;
for each individual recipe including the ingredient in the new ingredient container,
determining whether adjustments to the individual recipe are needed based on the ingredient quality information;
in response to a determination that adjustments are needed, adjusting the individual recipe to create a modified individual recipe based on the ingredient quality information; and
storing the modified individual recipe for use in preparing beverages that include the ingredient at the beverage robot.

2. The method of claim 1, wherein:
retrieving ingredient quality information related to an ingredient in the new ingredient container comprises: in response to the beverage robot scanning an identifier of the new ingredient container, retrieving, from a database, the concentration level of the ingredient in the new ingredient container; and
for each of the individual recipes including the ingredient in the new ingredient container,
determining whether adjustments to the individual recipe are needed comprises determining if the concentration level of the ingredient is outside of a predetermined range; and
adjusting the individual recipe to create the modified individual recipe comprises making one or more adjustments to the individual recipe to counteract the concentration level.

3. The method of claim 1, wherein:
retrieving ingredient quality information related to an ingredient in the new ingredient container comprises: in response to the beverage robot scanning an identifier of the new ingredient container, retrieving, from a database, the brix value of the ingredient in the new ingredient container; and
for each of the individual recipes including the ingredient in the new ingredient container,
determining whether adjustments to the individual recipe are needed comprises determining if the brix value of the ingredient is outside of a predetermined range; and
adjusting the individual recipe to create the modified individual recipe comprises making one or more adjustments to the individual recipe based on the brix value.

4. The method of claim 1, wherein the ingredient quality information is a first set of ingredient quality information and the modified recipe is a first modified recipe, and wherein the method further comprises:
receiving a second set of ingredient quality information of the ingredient in the new ingredient container;
determining the first set of ingredient quality information does not match the second set of ingredient quality information; and
in response to the first set of ingredient quality information not matching the second set of ingredient quality information, generating a second modified individual recipe based on the second set of ingredient quality information.

5. The method of claim 1, further comprising:
receiving an order requesting a beverage from the network;
in response to receiving the order, retrieving the modified individual recipe associated with the beverage to determine required ingredients for the beverage; and
checking a list of stored ingredients to determine if the beverage robot has the required ingredients to make the beverage according to the adjusted individual recipe.

6. The method of claim 1, further comprising:
receiving an order requesting a beverage from the network associated with an individual modified recipe;
assigning the beverage to the beverage robot from the one or more beverage robots, wherein assigning the beverage to the beverage robot causes the order to be added to a robotic queue at the beverage robot, and wherein the robotic queue is associated with beverages to be prepared by the beverage robot; and
preparing the beverage according to the individual modified recipe.

7. The method of claim 1, wherein the ingredient quality information further comprises an expiration date for the ingredient in the new ingredient container, and wherein the method further comprises:
determining the ingredient is expired based on the ingredient quality information; and
displaying, to an operator of the one or more beverage robots via a user interface on the beverage robot, a notification that the ingredient is expired.

8. A system comprising:
one or more processors; and
one or more memories storing instructions that, when executed by the one or more processors, cause the system to perform a process for operating a network having one or more beverage robots, the process comprising:
determining ingredient quality information related to an ingredient, wherein the ingredient quality information includes one or more of a an acidity level, a brix value, a nutrient table, content, and/or a concentration level for the ingredient in a beverage container;
for each individual recipe including the ingredient in the beverage container,
determining whether adjustments to the individual recipe are needed based on the ingredient quality information;
in response to a determination that adjustments are needed, adjusting the individual recipe to create an adjusted individual recipe based on the ingredient quality information; and
sending, to the one or more beverage robots, the adjusted individual recipe for use in preparing beverages that include the ingredient.

9. The system of claim 8, wherein the process further comprises:
determining the concentration level of the ingredient is outside of a predetermined range; and
in response to the concentration level being outside of the predetermined range, adjusting the individual recipe to create the adjusted individual recipe based on the concentration level.

10. The system of claim 8, wherein the process further comprises:
determining the brix value of the ingredient has reached a brix threshold; and
in response to the brix value reaching the brix threshold, adjusting the individual recipe to create the adjusted individual recipe based on the brix value.

11. The system of claim 8, wherein the ingredient quality information is first ingredient quality information, wherein the process further comprises:
retrieving, from a database, second ingredient quality information of the ingredient;
determining whether the first ingredient quality information matches the second ingredient quality information;
in response to the first ingredient quality information not matching the second ingredient quality information, generating a second adjusted individual recipe based on the second ingredient quality information; and
sending, to the one or more beverage robots, the second adjusted individual recipe for use in preparing beverages that include the ingredient.

12. The system of claim 8, wherein the process further comprises:
receiving an order requesting a beverage;
in response to receiving the order, retrieving the adjusted individual recipe associated with the beverage to determine required ingredients for the beverage; and
checking a list of stored ingredients to determine if the one or more beverage robots have the required ingredients to make the beverage according to the adjusted individual recipe.

13. The system of claim 8, wherein the process further comprises:
receiving an order requesting a beverage; and
assigning the beverage to a beverage robot from the one or more beverage robots, wherein assigning the beverage to the beverage robot causes the order to be added to a robotic queue at the beverage robot, and wherein the robotic queue is associated with beverages to be prepared by the beverage robot.

14. The system of claim 8, wherein the ingredient quality information further comprises an expiration date for the ingredient in the ingredient container, and wherein the process further comprises:
determining the ingredient is expired based on the ingredient quality information; and
sending, to the one or more beverage robots, a notification that the ingredient is expired.

15. A non-transitory computer-readable medium storing instructions that, when executed by a computing system, cause the computing system to perform operations for operating a network having one or more beverage robots, the operations comprising:
detecting a new ingredient container installed into a beverage robot from the one or more beverage robots;
retrieving ingredient quality information related to an ingredient in the new ingredient container, wherein the ingredient quality information includes one or more of a an acidity level, a brix value, a nutrient table, content, and/or a concentration level for the ingredient in the new ingredient container;
for each individual recipe including the ingredient in the new ingredient container,
determining whether adjustments to the individual recipe are needed based on the ingredient quality information;
in response to a determination that adjustments are needed, adjusting the individual recipe to create a modified individual recipe based on the ingredient quality information; and
storing the modified individual recipe for use in preparing beverages that include the ingredient at the beverage robot.

16. The non-transitory computer-readable medium of claim 15, wherein the operations further comprise:
retrieving, from a database, the concentration level of the ingredient in the new ingredient container;
determining the concentration level of the ingredient is outside of a predetermined range; and
in response to the concentration level being outside of the predetermined range, adjusting the individual recipe to create the adjusted individual recipe based on the concentration level.

17. The non-transitory computer-readable medium of claim 15, wherein the operations further comprise:
retrieving, from at least one database, the brix value of the ingredient in the new ingredient container;
determining the brix value of the ingredient has reached a brix threshold; and
in response to the brix value reaching the brix threshold, adjusting the individual recipe to create the adjusted individual recipe based on the brix value.

18. The non-transitory computer-readable medium of claim 15, wherein the ingredient quality information is first ingredient quality information, wherein the operations further comprise:
receiving second ingredient quality information of the ingredient in the new ingredient container;
determining the first ingredient quality information does not match the second ingredient quality information; and
in response to the first ingredient quality information not matching the second ingredient quality information, generate a second adjusted individual recipe based on the second ingredient quality information.

19. The non-transitory computer-readable medium of claim 15, wherein the operations further comprise:
receiving an order requesting a beverage from the network;
in response to receiving the order, retrieving the adjusted individual recipe associated with the beverage to determine required ingredients for the beverage; and
checking a list of stored ingredients to determine if the beverage robot has the required ingredients to make the beverage according to the adjusted individual recipe.

20. The non-transitory computer-readable medium of claim 15, wherein the operations further comprise:
receiving an order requesting a beverage from the network;
assigning the beverage to the beverage robot from the one or more beverage robots, wherein assigning the beverage to the beverage robot causes the order to be added to a robotic queue at the beverage robot, and wherein the robotic queue is associated with beverages to be prepared by the beverage robot; and
preparing the beverage according to the adjusted individual recipe.
